(19) United States
(12) Patent Application Publication
(10) Pub. No.: US 2008/0304933 A1
(43) Pub. Date: Dec. 11, 2008

(54) BOLT HOLDING MEMBER

(76) Inventors: Yukihiro KURATA, Tokyo (JP); Masafumi TOKUSHIGE, Yokohamashi-shi (JP); Nayomon UNO, Hasuda-shi (JP); Yoshihiko NAKAMURA, Nagareyama-shi (JP)

Correspondence Address: OSTROLENK FABER GERB & SOFFEN, 1180 AVENUE OF THE AMERICAS, NEW YORK, NY, 100368403, US

(21) Appl. No.: 12/133,005

(22) Filed: Jun. 4, 2008

(30) Foreign Application Priority Data
Jun. 5, 2007 (JP) 2007-149696
Nov. 22, 2007 (JP) 2007-302596
Dec. 20, 2007 (JP) 2007-329361

(51) Int. Cl. F16B 13/06

(52) U.S. Cl. 411/55; 411/82.2

(57) ABSTRACT

A bolt temporary fixing nut 9, one axial end of which has a smaller diameter than a bolt hole of a bottom steel plate 1 and an outer peripheral surface of which is made into a tapered shape which is increased in diameter from the one axial end toward the other axial end so as to have a larger diameter than the bolt hole 3, is formed. The bolt temporarily fixing nut 9 is threadedly attached to the bolt 5, which is inserted through the bolt hole 3 from the bottom, and the one axial end of the nut is forcibly screwed into a gap between the bolt hole 3 and the bolt 5, thereby temporarily fixing the bolt 5 to the bolt hole 3 so as not to rotate. Thereafter, after the splice plate 2 is placed on the bottom steel plate 1, the nut 6 is fastened to the bolt 5, thereby joining the bottom steel plate 1 and a splicing plate 2. According to the invention, it is possible to prevent the bolt, which is hold in the bolt held in advance, from co-rotating at the time of nut fastening.

### BACKGROUND OF THE INVENTION

1. Field of the Invention

The present invention relates to a steel plate joining method used in order to join overlapping portions of steel plates using a bolt, and a bolt holding nut used for the method. The present invention also relates to a rust-proofing method and an apparatus of a fastening bolt which is used in order to prevent rusting of the bolt which is temporarily fixed to a bolt hole of one of the steel plates in advance in order to fasten overlapping portions of steel plates.

Priority is claimed on Japanese Patent Application No. 2007-149696, filed Jun. 5, 2007, No. 2007-302596, filed Nov. 22, 2007, and No. 2007-329361, filed Dec. 20, 2007, the contents of which are incorporated herein by reference.

2. Description of Related Art

In recent years, as a plate deck for constructing a bridge, a composite plate deck of a type in which a panel-like bottom steel plate is used as a mold which forms the lower surface of a concrete layer of the plate deck as to directly cast concrete inside the bottom steel plate such that the bottom steel plate and the concrete layer are combined integrally has been increasingly used.

In order to construct this type of composite plate deck, first, the operation of connecting the adjacent bottom steel plates after the bottom steel plates are arranged in the direction of a span on a main girder becomes necessary.

In a case where the adjacent bottom steel plates are connected, typically, as shown in FIG. 5, bolts (high tensile bolts) 5 are inserted through bolt holes 3 and 4 bored in overlapping portions of each of the bottom steel plates 1 and the splicing plate 2 from the lower surface of the bottom steel plate 1 in a state where the splicing plate 2 is disposed above matching ends of the adjacent bottom steel plates 1. Thereafter, as a washer 7 is fitted to the tip of each of the bolts 5 which protrude above the splicing plate 2, and a nut 6 is then threadedly attached and screwed to the bolt, the overlapping portions of each of the bottom steel plates 1 and the splicing plate 2 as overlapping portions of steel plates are joined together by the bolt 5, and thereby the matching ends of the adjacent bottom steel plates 1 are connected via the splicing plate 2.

When the overlapping portions of the bottom steel plate 1 and the splicing plate 2 are joined together using the bolts 5 as described above, it is necessary to threadedly attach and screw the nut 6 from above the splicing plate 2 in a state where the bolt 5 inserted through the bolt holes 3 and 4 from the lower surface of the bottom steel plate 1 does not fall off (drop out).

Thus, as a technique for eliminating the operation with regard to the bottom steel plate from the lower surface of which in an installation site of the bottom steel plate 1 of the composite plate deck, a technique of making the bolt 5 inserted through the bolt hole 3 of the bottom steel plate 1 from the bottom held in the portion of the bolt hole 3 via a required jig so as not to fall off has been considered.

(a), (b), (c) of FIG. 6 show a conventionally proposed hooking ring 8, as an example of the jig for keeping the bolt 5 held in the bolt hole 3 of the bottom steel plate 1 from falling off.

The hooking ring 8 has an external diameter which is slightly larger than the bolt hole 3 bored in the bottom steel plate 1, and is configured such that an internally threaded portion (not shown) for being threadedly attached to a shank 5a (threaded portion) of the bolt 5 is provided on the inner peripheral surface of a ring-shaped member whose axial length (height) is made smaller than the thickness of the splicing plate 2. Thereby, as shown in (a) of FIG. 6, after the bolts 5 are inserted into the bolt holes 3 provided at the matching ends of the adjacent bottom steel plates 1 from the bottom, the hooking ring 8 is fitted on the shank 5a of each of the bolts 5 by screw coupling from the top, and the hooking ring 8 is applied to the periphery of the bolt hole 3 of each of the bottom steel plates 1, so that the bolt 5 can be held in advance in the bolt hole 3 of each of the bottom steel plates 1 in a state where the bolt 5 is prevented from falling out.

Accordingly, after that, as shown in (b) of FIG. 6, the splicing plate 2 which is obtained by boring a bolt hole 4 of such a size that the hooking ring 8 can pass therethrough is placed on to the matching ends of the bottom steel plates 1 from the top such that the bolt 5 held in the bolt hole 3 of each of the bottom steel plates 1 is inserted through the bolt hole 4. Then, as shown in (c) of FIG. 6, the nut 6 is fastened to the bolt 5 from the top via the washer 7 from above the splicing plate 2. Thereby, the joining operation of the splicing plate 2 to each of the bottom steel plates 1, i.e., the connection operation of the bottom steel plates 1 via the splicing plate 2 can be carried out only by the operation from above the bottom steel plate 1 (for example, refer to Patent Document 1).

Meanwhile, although zinc spraying is considered at the beginning as a rust-proofing treatment at the lower surface of the bottom steel plate 1 which becomes the rear surface of the composite plate deck, recently, painting is often performed on the whole surface at the lower surface of the bottom steel plate 1.

Therefore, it has been considered that preliminary painting can be performed in a factory, etc., on the whole lower surface of the bottom steel plate 1 including the head of the bolt 5, in a state where the bolt 5 is inserted through the bolt hole 3—so that the painting operation from the lower surface of the bottom steel plate 1 in an installation site of the bottom steel plate 1 can be omitted.

In addition, as one of the methods for joining bottom steel plates of a girder block which constitutes a composite plate deck or bottom steel plates of a steel plate panel which constitutes a composite plate deck, as shown in (a), (b), (c) of FIG. 15, a joining method (for example, refer to Patent Document 2) of bottom steel plates including inserting a high tensile bolt (bolt) 5 into a bolt hole 3 from the lower surface to fix the high tensile bolt 5 by means of a primary nut 9, performing painting at the lower surface of the bottom steel plate 1 to which the high tensile bolt 5 is fixed, installing a filler plate 10 having an opening 11 which receives the primary nut 9 on the bottom steel plate 1, disposing a splicing plate 2 over the adjacent bottom steel plates 1 above each filler plate 10, and performing fastening by means of a secondary nut 12 from the upper surface of the splicing plate 2 is conventionally suggested.

Meanwhile, since the hooking ring 8 fitted to the threaded portion 5a of the bolt 5 by screw coupling contacts a peripheral edge of an upper end of the bolt hole 3 in the upper surface of the bottom steel plate 1, the contact area between the lower surface of the hooking ring 8 and the upper surface of the bottom steel plate 1 is limited so as to be small only at an outer peripheral edge of a lower end surface. Accordingly, it is difficult to increase the frictional force between the bottom steel plate 1 and the hooking ring 8. Therefore, in actuality, when the nut 6 is threadedly attached and fastened to the bolt 5 held in the hole 3, there is a possibility that co-rotation may be caused in the bolt 5.

Therefore, even if the bolt 5 is held in the bolt hole 3 in a factory, etc. in a state where its falling-off is prevented using the hooking ring 8, if co-rotation of the bolt 5 is caused at the time of fastening the nut 6 onto the bolt 5, there is a possibility that a paint film may break or peeling may occur. Therefore, it is difficult to perform preliminary painting over the whole lower surface of the bottom steel plate 1 including the head of the bolt 5.

Moreover, there is a possibility that the center of the bolt hole 3 and the center of the bolt 5 may be misaligned with each other in a state where the hooking ring 8 is inserted into the threaded portion 5a of the bolt 5 inserted through the bolt hole 3 from the bottom by screw coupling. In addition, there is also a problem in that the hooking ring 8 is easily loosened due to vibration or the like during the transportation of the bottom steel plate 1. Moreover, since the degree of adhesion of the hooking ring 8 and the peripheral edge of the bolt hole 3 on which the hooking ring 8 contacts, is low, and sealing performance is inferior, if the period until the installation of the bottom steel plate 1 is long in a state where the bolt 5 is held in the bolt hole 3 using the hooking ring 8. There is also a possibility that rust may be generated in a portion of the threaded portion 5a of the bolt 5 located inside the bolt hole 3 due to moisture or the like.

On the other hand, the idea of performing painting at the lower surface of the bottom steel plate 1 to which the high tensile bolt 5 is fixed after being inserted into the bolt hole 3 from the lower surface and fixed by the primary nut 9 is shown in the above Patent Document 2.

However, in the technique shown in this Patent Document 2, the primary nut 9 used in order to fix the high tensile bolt 5 to the bolt hole 3 has the same planar shape as a typical nut, and has a thickness of 4 mm so that the screwing operation to the high tensile bolt 5 can be efficiently performed using mechanical driving tools, such as a general-purpose impact wrench. However, while the primary nut 9 is screwed over the entire length of the portion which has protruded above the upper surface of the bottom steel plate 1 in the threaded portion of the high tensile bolt 5 inserted through the bolt hole 3 from the lower surface, the head of the high tensile bolt 5 should be held on the lower surface of the bottom steel plate 1 so as not to be co-rotated. Therefore, there is a problem in that the amount of operation time to perform upper and lower operations with the bottom steel plate 1 therebetween is long, and manpower is required.

In addition, the primary nut 9 has the same planar shape as a normal nut. Therefore, in the technique shown in Patent Document 2, when the splicing plate 2 is placed on the bottom steel plate 1, the filler plate 10 having a larger thickness than the primary nut 9 should be interposed between the bottom steel plate 1 and the splicing plate 2. Moreover, it is necessary to provide the filler plate 10 with a large opening 11 for receiving the primary nut 9 having the same planar shape as a normal nut, in a portion through which the high tensile bolt 5 is inserted. Therefore, when the secondary nut 12 is fastened to the bolt 5 which is fixed to the bottom steel plate 1 in advance from above the splicing plate 2 after the filler plate 10 and the splicing plate 2 are placed in order on the bottom steel plate 1, a portion to which the fastening axial force is transmitted between the bottom steel plate 1 and the splicing plate 2 is limited to the periphery of the large opening 11 of the filler plate 10. For this reason, there is a possibility that a problem in the frictional joining between the bottom steel plate 1 and the splicing plate 2 may occur.

Moreover, even in the technique shown in Patent Document 2, when the high tensile bolt 5 inserted through the bolt hole 3 using the primary nut 9 is fixed, there is a possibility that the center of the bolt hole 3 and the center of the high tensile bolt 5 may be misaligned with each other. Moreover, the primary nut 9 is made of the same material as a normal nut. Therefore, although the lower surface of the primary nut 9 is pressed against the peripheral edge of the bolt hole 3 by fastening the primary nut 9 to the high tensile bolt 5, sealing performance is not necessarily high. Accordingly, when the period until the installation of the bottom steel plate 1 is long in a state where the high tensile bolt 5 is held in the bolt hole 3 using the primary nut 9, there is also a possibility that rust is generated in the portion of the threaded portion of the high tensile bolt 5 located inside the bolt hole 3 due to moisture or the like.

Thus, the invention provides a bolt temporary fixing nut capable of temporarily fixing a bolt used for the joining between overlapping portions of steel plates to a bolt hole of the steel plate which requires the bolt to be first inserted therethrough, capable of firmly joining the overlapping portions of the steel plates without requiring a filler plate, capable of preventing co-rotation of the bolt even when the nut is finally fastened to the bolt for the joining between the overlapping portions of the steel plates, and capable of performing preliminary painting of a head of the bolt used to join the overlapping portions of the steel plates together with the surface of the steel plate around the head of the bolt.

Meanwhile, in the conventional technique to hold the bolt 5 in the bolt hole 3 in advance in a state where its falling-off is prevented using a jig similar to the hooking ring 8 shown in Patent Document 1, there is a possibility that co-rotation may occur in the bolt 5 when the nut 6 is fastened to the bolt 5 held in the bolt hole 3 in an installation site of the bottom steel plate 1.

That is, since it is necessary to insert the hooking ring 8 shown in the above-mentioned Patent Document 1 into the bolt hole 4 of the splicing plate 2 in a state where the hooking ring 8 is fitted onto the shank 5a of the bolt 5, the thickness of a peripheral wall cannot be set to a large value. In addition, since it is necessary to set the axial length of the hooking ring 8 to be smaller than the thickness of the splicing plate 2, the number of threads axially arrayed in an internally threaded portion of in the inner peripheral surface is limited to a small number. Consequently, the fastening axial force onto the bolt 5 can not be large.

Moreover, generally, the internal diameter of the bolt hole 3 is made to have a slight allowance with respect to the diameter of the shank 5a of the bolt 5. Therefore, the hooking ring 8 fitted to the shank 5a of the bolt 5 by screw coupling is adapted to contact the peripheral edge of the upper end of the bolt hole 3 in the upper surface of the bottom steel plate 1 only at the outer periphery edge of the lower end surface thereof.

Therefore, the contact area between the lower surface of the hooking ring 8 and the upper surface of the bottom steel plate 1 is limited so as to be small.

Accordingly, it is difficult to increase the frictional force between the bottom steel plate 1 and the hooking ring 8. Therefore, in actuality, when the nut 6 is threadedly attached and fastened to the bolt 5 held in the hole 3 of the bottom steel plate 1, there is a possibility that co-rotation may be caused in the bolt 5.

Therefore, even if preliminary painting is performed on the whole lower surface of the bottom steel plate 1 including the head of the bolt 5 after the bolt 5 is held in the bolt hole 3 in a factory, etc. in a state where its falling-off is prevented using the hooking ring 8, there is a possibility that a paint film may break or peeling may occur if co-rotation of the bolt 5 is caused due to fastening of the nut 6 onto the bolt 5. Therefore, it is conventionally difficult to perform preliminary painting over the whole lower surface of the bottom steel plate 1.

Conventionally, preliminary painting is performed in a factory, etc only on the region other than the periphery of the bolt hole 3 in the lower surface of the bottom steel plate 1. Then, in an installation site of the bottom steel plate 1, it is necessary to perform painting on a non-painted portion of the periphery of the bolt hole 3 and the head of the bolt 5 in the lower surface of the bottom steel plate 1 after the joining operation of the matching ends of the adjacent bottom steel plates 1 as described above using the bolt 5 of the splicing plate 2 is performed to connect the bottom steel plates 1 together.

The present invention provides a steel plate joining method, and a bolt temporary fixing nut used for the method, capable of preventing a possibility that co-rotation may be caused even at the time of fastening of the nut in a bolt held in a bolt hole of one steel plate so as not to fall off when overlapping portions of steel plates are joined together using the bolt, and capable of performing preliminary painting of a head of the bolt used to join the overlapping portions of the steel plates together with the surface of the steel plate around the head of the bolt.

Moreover, the bolt 5 which is temporarily fixed to the bolt hole 3 of each of the bottom steel plates 1 as described above is exposed to the outdoors until the nut 6 for joining each of the bottom steel plates 1 and the splicing plate 2 is finally fastened to the bolt 5, through the steps of carrying the bottom steel plates 1 into a construction site after the temporarily fixing operation, disposing the bottom steel plates 1 side by side in the direction of a span on a main girder, placing the splicing plate 2 on matching ends of the adjacent bottom steel plates 1, and correcting the position of each bottom steel plate 1 in which the bolt 5 is temporarily fixed to the bolt hole 3, by using the position of the bolt hole 4 of the splicing plate 2.

Therefore, after the moment of temporary fixing operation of the bolt 5 to the bolt hole 3 is performed, if the period until final fastening operation on the spot is long, there is a possibility that rust may be generated in the threaded portion of the bolt 5. Also, if rust is generated in the threaded portion 5a of the bolt 5, there is a problem in that a torque coefficient is disturbed and the axial force after the final fastening becomes unstable.

Thus, conventionally, generation of rust in the threaded portion 5a of the bolt 5, after the temporarily fixing operation to the bolt hole 3 is performed until the final fastening operation on the spot, is suppressed by using a bolt 5, on which rust-proofing treatment is performed in advance, which is temporarily fixed to the bottom steel plate 1.

In addition, as shown in FIG. 30, as one of the methods for performing the corrosion-proofing (rust-proofing) of a threaded portion 11a of a bolt 11 and of a nut 12 which is fastened for joining plates 9 and 10, a technique of manufacturing a corrosion-proofing cap 13 composed of a thread coating portion 13a which covers the tip and side surface of the threaded portion 11a, a head coating portion 13b which covers the nut 12, a flange coating portion 13c which covers a flange 12a of the nut 12, and a plate coating portion 13d which spreads along the plate 9 by means of PVC containing zinc powder, and mounting the corrosion-proofing cap 13 so as to cover the threaded portion 11a and nut 12 is conventionally suggested (for example, refer to Patent Document 3).

Patent Document 1: Japanese Unexamined Patent Application, First Publication No. 2004-176909.

Patent Document 2: Japanese Unexamined Patent Application, First Publication No. 2006-207116.

Patent Document 2: Japanese Unexamined Patent Application, First Publication No. H09-250531.

Meanwhile, in a case where the bolt 5 has been subjected to rust-proofing treatment in advance and is temporarily fixed to the bolt hole 3 shown in the Patent Document 1, there is a problem in that cost increases significantly as compared with the case where a general bolt (high tensile bolt) is used, due to the number of bolts 5 used for the installation of a composite plate deck of a bridge being huge.

Moreover, although it is conceivable to cover the corrosion-proofing cap 13 described in Patent Document 3 on the bolt 5 as a measure for achieving rust-proofing of the threaded portion 5a of the bolt 5 which is temporarily fixed to the bolt hole 3, the corrosion-proofing cap 13 can not cut off the contact between the threaded portion of the bolt which is a corrosion-proofing target and the ambient air.

That is, the corrosion-proofing cap 13 shown in FIG. 30 is not adapted to be able to seal a portion between the plate coating portion 13d and the plate 9, and has a spiral spatial portion which exists along a thread groove even in a state where the cap is mounted so as to cover the tip and side surface of the threaded portion 11a of the bolt 11 by the thread coating portion 13a. Moreover, the portion of the threaded portion 11a of the bolt 11 to which the nut 12 is threadedly attached is not adapted to be able to be sealed because a narrow spatial portion remains so as to extend in a spiral direction between an external thread of the threaded portion 11a and an internal thread of the nut 12. Therefore, air or water cannot be prevented from entering the spiral space of the threadedly attached portion of the bolt 11 and the nut 12, or the spiral spatial portion extending along the groove of the threaded portion 11a. Consequently, in actuality, it is difficult to reliably prevent the generation of rust in the threaded portion 11a.

Thus, the invention provides a rust-proofing method and apparatus of a fastening bolt capable of cutting off the contact of a bolt with the ambient air in a state where the bolt is inserted through a bolt hole of one steel plate of two overlapping steel plates in order to join overlapping portions of the two steel plates, thereby performing rust-proofing of the threaded portion of the bolt.

### SUMMARY OF THE INVENTION

In order to achieve the above object, a first aspect of the invention is a bolt temporary fixing nut for temporarily fixing a bolt inserted through the overlapping portions of a plurality of steel plates to join the plurality of steel plates by way of a bolt hole of a predetermined steel plate. An internally threaded portion is provided in an inner peripheral surface of the bolt temporary fixing nut, a tapered portion is provided at an outer periphery of a cylindrical portion of the bolt temporary fixing nut, and the tapered portion has an external diameter which is gradually reduced in diameter toward an axial direction of the cylindrical portion so as to become a diameter which is smaller than the bolt hole of the predetermined steel plate from a diameter which is larger than the bolt hole. The tapered portion is brought into pressure contact with the bolt hole of the predetermined steel plate if the bolt temporary fixing nut is threadedly attached to the bolt until the nut does not move in a state where the bolt is inserted into the bolt hole of the predetermined steel plate.

A second aspect of the invention is the bolt temporary fixing nut according to the first aspect, wherein the tapered portion is composed of two tapered surfaces which have different inclination angles with respect to the axial direction, and the inclination angle of the tapered surface on the side of the cylindrical portion (on the side of the other end surface) with respect to the axial direction becomes larger than the inclination angle of the tapered surface on the side of one axial end (on the side of one end surface) with respect to the axial direction.

A third aspect of the invention is the bolt temporary fixing nut according to the second aspect, wherein the external diameter of a boundary between the two tapered surfaces in the tapered portion becomes larger than the bolt hole of the predetermined steel plate by a desired amount.

A fourth aspect of the invention is the bolt temporary fixing nut according to any one of the first to the third aspects, wherein a screw-less portion is provided in an inner peripheral surface of the tapered portion at one axial end.

A fifth aspect of the invention is the bolt temporary fixing nut according to any one of the first to the fourth aspects, wherein the bolt temporary fixing nut is made of resin which can permit elastic deformation.

A sixth aspect of the invention is the bolt temporary fixing nut according to the fifth aspect, wherein the internally threaded portion has a thread with a shape which is obtained by cutting a tip thereof.

A seventh aspect of the invention is the bolt temporary fixing nut according to any one of the first to the sixth aspects, wherein the other axial end of the cylindrical portion is provided with a cap attaching portion whose external diameter is smaller than the external diameter of the cylindrical portion by a desired amount.

An eighth aspect of the invention is the bolt temporary fixing nut according to the seventh aspect, wherein a stepped portion is provided at an axial intermediate portion of the cap attaching portion over its entire periphery.

A ninth aspect of the invention is the bolt temporary fixing nut according to the first aspect, including a stepped surface in a direction perpendicular to the axial direction.

A tenth aspect of the invention is a bolt temporary fixing method including inserting a bolt through a bolt hole of one steel plate of two overlapping steel plates which are to be joined using the bolt from one surface, and threadedly attaching the bolt temporary fixing nut according to the first aspect to a shank of the bolt from said one end surface of the temporary fixing nut, and screwing the one axial end (one end surface) of the bolt temporary fixing nut into a gap between the bolt hole of the one steel plate and the bolt, thereby temporarily fixing the bolt to the one steel plate in advance.

An eleventh aspect of the invention is a bolt temporary fixing method including temporarily fixing the bolt to the one steel plate in advance by the bolt temporary fixing method according to the tenth aspect, then disposing the other steel plate in which a bolt hole which is larger than the maximum diameter of the bolt temporary fixing nut is bored at the other surface of the one steel plate, and then threadedly attaching and fastening the nut to the bolt, thereby joining the two overlapping steel plates.

A twelfth aspect of the invention is a steel plate joining method including temporarily fixing the bolt to the one steel plate in advance by the bolt temporary fixing method according to the tenth aspect, then preliminarily painting a region including a head of the bolt at one surface of the one steel plate, then disposing the other steel plate, in which a bolt hole which is larger than the maximum diameter of the bolt temporary fixing nut is bored, at the other surface of the one steel plate, and then threadedly attaching and fastening the nut to the bolt, thereby joining the two overlapping steel plates.

A thirteenth aspect of the invention is a rust-proofing method of a fastening nut including temporarily fixing a bolt inserted through a bolt hole of one steel plate of two overlapping steel plates which are to be joined using the bolt from one surface, via the bolt temporary fixing nut according to the first aspect, sealing an end on the side of the other surface at an inner peripheral surface of the bolt hole of the one steel plate by an outer peripheral surface of the bolt temporary fixing nut, thereby preventing water from entering the bolt hole, and bringing an opening at the other longitudinal end of a rust-proofing cap, one longitudinal end of which is made into a closed tubular shape, which covers the tip and side surface of a threaded portion of the bolt, into contact with the bolt temporary fixing nut, thereby sealing a portion between the opening of the rust-proofing cap and the bolt temporary fixing nut, and sealing a portion between the head of the bolt and the one surface of the one steel plate by painting.

A fourteenth aspect of the invention is the rust-proofing method of a fastening nut according to the thirteenth aspect, wherein the bolt temporary fixing nut, having a tapered shape so that the external diameter at one end of which becomes smaller than the external diameter at the other end thereof, is threadedly attached to the bolt inserted through the bolt hole of the one steel plate of the two overlapping steel plates from one surface, and the one axial end of the bolt temporary fixing nut is pushed into the gap between the bolt hole of the one steel plate and the bolt, thereby temporary fixing the bolt, and sealing a portion between an end on the side of the other surface at the inner peripheral surface of the bolt hole of the one steel plate and the bolt temporary fixing nut.

A fifteenth aspect of the invention is the rust-proofing method of a fastening nut according to the thirteenth aspect, wherein the bolt to which the bolt temporary fixing nut having an external diameter larger than the bolt hole by a desired amount is threadedly attached is pushed into the bolt hole of one steel plate of the two overlapping steel plates together with the bolt temporary fixing nut from one surface of the one steel plate, thereby temporarily fixing the bolt, and sealing a portion between an end on the side of the other surface at the inner peripheral surface of the bolt hole of the one steel plate and the bolt temporary fixing nut.

A sixteenth aspect of the invention is the rust-proofing method of a fastening nut according to the thirteenth aspect, wherein the bolt to which the bolt temporary fixing nut including a locking protruding portion having an external diameter larger than the bolt hole by a desired amount is threadedly attached is pushed into the bolt hole of one steel plate of the two overlapping steel plates together with the bolt temporary fixing nut from one surface of the one steel plate until the locking protruding portion of the bolt temporary fixing nut passes through the bolt hole of the one steel plate and appears at the other surface, and then the locking protruding portion of the bolt temporary fixing nut is pushed into a gap between the bolt hole of the one steel plate and the bolt, thereby temporarily fixing the bolt and sealing a portion between an end on the side of the other surface at the inner peripheral surface of the bolt hole of the one steel plate and the bolt temporary fixing nut.

A seventeenth aspect of the invention is a rust-proofing apparatus of a fastening nut including the bolt temporary fixing nut according to the first aspect which can be brought into close contact with an end on the side of the other surface at the bolt hole of the one steel plate, in a state of being threadedly mounted on a threaded portion of a bolt inserted through a bolt hole of the one steel plate of two overlapping steel plates, which are to be joined, by using the bolt from one surface, and a rust-proofing cap whose one longitudinal end is made into a closed tubular shape provided with a body portion at one longitudinal end being covered on the tip and side surface of the threaded portion of the bolt and an opening at the other longitudinal end being brought into contact with the bolt temporary fixing nut for sealing a portion between the opening of the rust-proofing cap and the bolt temporary fixing nut, thereby sealing a portion between the head of the bolt and the one surface of the one steel plate by painting.

An eighteenth aspect of the invention is the rust-proofing apparatus of a fastening nut according to the seventeenth aspect, wherein the bolt temporary fixing nut has a cap attaching portion for attaching the rust-proofing cap at the other axial end of the tapered portion.

A nineteenth aspect of the invention is the rust-proofing apparatus of a fastening nut according to the eighteenth aspect, wherein a locking tapered surface portion, having an inclination angle that increases with respect to an axial direction, is provided at the other axial end of the portion of the tapered portion whose external diameter becomes larger than the bolt hole of the one steel plate by a desired amount.

A twentieth aspect of the invention is the rust-proofing apparatus of a fastening nut according to the seventeenth aspect, wherein the bolt temporary fixing nut is configured to have a cap attaching portion for attaching the rust-proofing cap at one axial end of the cylindrical portion having an external diameter which is larger by a desired amount than the bolt hole of one steel plate of the two overlapping steel plates, and is pushed into the bolt hole of the one steel plate in a state of being threadedly attached to the threaded portion of the bolt, so that the bolt temporary fixing nut can be brought into close contact with and fixed to the inside of the bolt hole by a restoring force of elastic deformation which is compressed in the radial direction in the gap between the bolt hole and the bolt.

A twenty-first aspect of the invention is the rust-proofing apparatus of a fastening nut according to the twentieth aspect, wherein ring-shaped grooves are provided at a plurality of positions of axially desired intervals in the outer peripheral surface of the cylindrical portion of the bolt temporary fixing nut.

A twenty-second aspect of the invention is the rust-proofing apparatus of a fastening nut according to the seventeenth aspect, wherein the bolt temporary fixing nut has a cylindrical member having a diameter which is smaller than the bolt hole of one steel plate of the two overlapping steel plates provided with an outer peripheral surface of the one axial end as a cap attaching portion for attaching the rust-proofing cap, and a locking protruding portion provided in an axial intermediate portion of the cylindrical member which has a larger diameter than the bolt hole of the one steel plate which is elastically deformable toward the axial center.

A twenty-third aspect of the invention is the rust-proofing apparatus of a fastening nut according to the twenty-second aspect, wherein a cylindrical portion which has the same or slightly larger diameter than the bolt hole of the one steel plate of the two overlapping steel plates is provided closer to the other axial end than the locking protruding portion in the bolt temporary fixing nut.

A twenty fourth aspect of the invention is the rust-proofing apparatus of a fastening nut according to the seventeenth to twenty-third aspects, wherein the cap attaching portion in the bolt temporary fixing nut is cylindrical, and the internal diameter of the opening of the rust-proofing cap is slightly smaller than the external diameter of the cap attaching portion.

A twenty-fifth aspect of the invention is the rust-proofing apparatus of a fastening nut according to the twenty-fourth aspects, wherein a groove is provided at an axial intermediate portion of the cylindrical cap attaching portion of the bolt temporary fixing nut.

According to the invention, the following excellent effects are exhibited.

According to first aspect of the invention, there is provided a bolt temporary fixing nut for temporarily fixing a bolt inserted through the overlapping portions of a plurality of steel plates to join the plurality of steel plates in a bolt hole of a predetermined steel plate. A tapered portion is provided in a cylindrical portion of the bolt, the maximum external diameter of the tapered portion is larger than that of the bolt hole of the predetermined steel plate, and the minimum external diameter of the tapered portion is smaller in diameter than that of the bolt hole of the predetermined steel plate. The bolt temporary fixing nut which has an internally threaded portion at an inner peripheral surface of the bolt, and a torque-shear-type high tensile bolt for being inserted through the overlapping portions of the plurality of steel plates to join the plurality of steel plates is inserted through the bolt hole of the predetermined steel plate from one surface, and then the bolt temporary fixing nut is threadedly attached from the tapered portion of the bolt temporary fixing nut. Thus, when the bolt is temporarily fixed to the bolt hole of the predetermined steel plate, the workload of the concurrent operation on both surfaces of the predetermined steel plate can be reduced, and working efficiency can be made high. Therefore, the number of labor hours and the operation time which are required for the concurrent operation on both the upper and lower surfaces of the predetermined steel plate can be reduced.

According to the second and third aspects of the invention, the tapered portion is composed of two tapered surfaces which has different inclination angles with respect to the axial direction, and the inclination angle of the tapered surface on the side of the cylindrical portion to the axial direction becomes larger than the inclination angle of the tapered surface on the one axial end to the axial direction. More specifically, the external diameter of a boundary between the two tapered surfaces becomes larger than the bolt hole of the predetermined steel plate by a desired amount. Thereby, if the tapered surface on the cylindrical portion reaches the end of the other surface of the bolt hole of the predetermined steel plate, the force which bites into a gap between the bolt hole and the bolt becomes large. Therefore, the adhesiveness of the bolt temporary fixing nut to the inner peripheral surface of the end on the side of the other surface of the bolt hole of the predetermined steel plate can be increased, and the anti-rotational effect of the bolt which is temporarily fixed by the fastening axial force onto the bolt temporary fixing nut can be further strengthened.

According to the second and third aspects of the invention, the longitudinal position of the bolt temporary fixing nut to the bolt hole of the predetermined steel plate is determined. Therefore, the fastening amount of the bolt to the bolt temporary fixing nut can be made constant. Moreover, even in a case where the bolt hole of the bottom steel plate is slightly larger than a designed amount, the portion of the tapered surface on the side of the cylindrical portion of the bolt temporary fixing nut can be made to bite into the gap between the bolt hole of the predetermined bottom steel plate and the bolt in a wedge shape. Therefore, the bolt can be surely fixed in a state where its rotation is prevented by the fastening axial force onto the bolt temporary fixing nut.

According to the fourth aspect of the invention, a screw-less portion is provided in an inner peripheral surface of the tapered portion at one axial end. Thereby, even in a case where a region where no thread is engraved or an incomplete threaded portion exists in an under-head portion in the vicinity of the head of the bolt, the bolt temporary fixing nut can be screwed to the under-head portion of the bolt. Therefore, the fastening axial force onto the predetermined steel plate can be reliably made to act between the head of the bolt inserted through the bolt hole of the predetermined steel plate, and the tapered portion of the bolt temporary fixing nut threadedly attached to the threaded portion of the bolt.

According to the fifth aspect of the invention, the bolt temporary fixing nut is made of a resin which can permit elastic deformation. Thereby, the outer peripheral surface of the tapered portion can be more reliably brought into close contact with the end of the inner peripheral surface of the other surface in the bolt hole of the predetermined steel plate. Therefore, it is possible to enhance the anti-loosening effect of the bolt temporary fixing nut. Moreover, it is possible to easily mold the bolt temporary fixing nut having a complicated shape. Therefore, it is possible to make the bolt temporary fixing nut advantageous to mass production, and it is possible to make a unit price low. Moreover, since corrosion of the bolt temporary fixing nut can be prevented, the possibility that the robustness of the bolt is affected can be prevented.

According to the sixth aspect of the invention, the internally threaded portion has a thread with a shape which is obtained by cutting the tip thereof. Thereby, as the portion where the thickness in the peripheral wall of the bolt temporary fixing nut changes abruptly is reduced, the possibility of the occurrence of shrinkage can be reduced in the resin molding at the time of the manufacture of the bolt temporary fixing nut, so that the manufacture precision of the bolt temporary fixing nut can be made high.

According to the seventh aspect of the invention, the bolt temporary fixing nut is configured such that the cylindrical portion is provided at the side of the other axial end of the tapered portion. Therefore, the external diameter of the bolt temporary fixing nut can be made relatively small, and the diameter of a bolt hole provided in a bolt insertion portion of a different steel plate to be overlapped with and joined to the predetermined steel plate can be made small. Moreover, overlapping portions of the steel plates can be joined together without requiring a filler plate. Consequently, it is possible to secure the robust frictional joining between the predetermined steel plate and the different steel plate.

According to the seventh aspect of the invention, the bolt temporary fixing nut is provided with a cylindrical portion. Thereby, it is possible to reduce a thin-walled portion and to suppress the change of the wall thickness in the axial direction. Thus, it is possible to secure the strength as a nut capable of making a large fastening axial force act between the high tensile bolt and the bolt temporary fixing nut. Consequently, the bolt can be temporarily fixed to the bolt hole of the predetermined steel plate in a state where its rotation is prevented by a large fastening axial force onto the bolt temporary fixing nut.

Moreover, according to the seventh aspect of the invention, the other axial end of the cylindrical portion is provided with a cap attaching portion whose external diameter becomes smaller than the external diameter of the cylindrical portion by a desired amount. Thereby, by covering and attaching the cap attaching portion by the opening of the rust-proofing cap, which covers the tip side and its periphery of the threaded portion of the bolt which is temporarily fixed to the predetermined steel plate, it is possible to achieve rust-proofing of the bolt in a state of being temporary fixed to the predetermined steel plate. Moreover, it is possible to make small the external diameter of the opening of the rust-proofing cap for covering and attaching the outer periphery of the cap attaching portion. Therefore, even in a case where the dimensional difference between the diameter of the bolt hole of a different steel plate to be overlapped with and joined to the predetermined steel plate and the external diameter of the cylindrical portion of the bolt temporary fixing nut is small, it is possible to obtain a configuration, which is advantageous, when the bolt, which is temporarily fixed to the bolt hole of the predetermined steel plate, is inserted through the bolt hole of the different steel plate with the rust-proofing cap thereon.

According to the eighth aspect of the invention, a stepped portion is provided at an axial intermediate portion of the cap attaching portion over its entire periphery. Thereby, like the seventh aspect, it is possible to increase the sealing performance between the opening of the rust-proofing cap attached to the cap attaching portion, and the cap attaching portion of the bolt temporary fixing nut.

According to the ninth aspect of the invention, in the bolt temporary fixing nut of the above configuration, a stepped surface in a direction perpendicular to the axial direction is provided at the other axial end of the portion whose external diameter becomes larger than the bolt of the one steel plate by a desired amount. Thereby, when the one axial end of the bolt temporary fixing nut is made to bite into the gap between the bolt hole of the one steel plate and the bolt 5, the stepped surface is brought into contact with the outer peripheral surface of the bolt hole in the one steel plate, so that the amount of screwing into the gap between the bolt hole of the bolt temporary fixing nut and the bolt can be made constant. Moreover, the stepped surface provided in the bolt temporary fixing nut is brought into close contact with the outer peripheral edge of the bolt hole in the one steel plate. Thereby, it is possible to further strengthen the anti-rotational effect of the bolt which is temporarily fixed to the bolt hole of the one steel plate via the bolt temporary fixing nut by the frictional force caused in the closely contacted portion.

According to the tenth aspect of the invention, a bolt temporary fixing method includes inserting a bolt through a bolt hole of one steel plate of two overlapping steel plates which are to be joined using the bolt from one surface, and then threadedly attaching the bolt temporary fixing nut having a tapered shape. The external diameter at one end of the temporary fixing nut becomes smaller than the external diameter at the other end thereof. The temporary fixing nut attaches to a shank of the bolt from one end, and screws the one axial end thereof into a gap between the bolt hole of the one steel plate and the bolt, thereby temporarily fixing the bolt to the one steel plate in advance. Thereby, the joining operation of the other steel plate to the one steel plate can be carried out only by the operation from the other surface of the one steel plate in which a bolt is temporarily fixed to the bolt hole. Moreover, when the nut is threadedly attached and fastened to the bolt which is temporarily fixed to the bolt hole of the one steel plate, co-rotation can be prevented.

According to the eleventh aspect of the invention, a bolt temporary fixing method includes inserting a bolt through a bolt hole of one steel plate of two overlapping steel plates which are to be joined using the bolt from one surface, then threadedly attaching the bolt temporary fixing nut having a tapered shape. The external diameter at one end of which becomes smaller than the external diameter at the other end thereof. The temporary fixing nut attaches to a shank of the bolt from one end, and screws the one axial end of the bolt temporary fixing nut into a gap between the bolt hole of the one steel plate and the bolt, thereby temporarily fixing the bolt to the one steel plate in advance, disposing the other steel plate, in which a bolt hole larger than the maximum diameter of the bolt temporary fixing nut is bored, at the other surface of the one steel plate, and threadedly attaching and fastening the nut to the bolt, thereby joining the two overlapping steel plates. Thus, the joining operation of the other steel plate to the one steel plate can be carried out only by the operation from the other surface of the one steel plate in which a bolt is temporarily fixed to the bolt hole. Moreover, when the nut is threadedly attached and fastened to the bolt which is temporarily fixed to the bolt hole of the one steel plate, co-rotation can be prevented.

According to the twelfth aspect of the invention, similarly to above, a steel plate joining method includes screwing the one axial end of the bolt temporary fixing nut into a gap between the bolt hole of the one steel plate and the bolt, thereby temporarily fixing the bolt to the one steel plate in advance, then preliminarily painting a region including the head of the bolt at one surface of the one steel plate, then joining the other steel plate at the other surface of the one steel plate. Thereby, while cracking or peeling in preliminary painting performed on the one surface of the one steel plate can be prevented, the operation of joining the other steel plate to the one steel plate can be carried out only by the operation from the other surface of the one steel plate. Accordingly, in a site where the steel plates are joined together, it is possible to make the operation on the side of the one surface of the one steel plate unnecessary.

According to the thirteenth aspect of the invention, a rust-proofing method of a fastening nut includes temporarily fixing a bolt inserted through a bolt hole of one steel plate of two overlapping steel plates which are to be joined using the bolt from one surface via the bolt temporary fixing nut, sealing an end on the side of the other surface at an inner peripheral surface of the bolt hole of the one steel plate at an outer peripheral surface of the bolt temporary fixing nut, so as to prevent water from entering the bolt hole, and bringing an opening at the other longitudinal end of a rust-proofing cap, one longitudinal end of which is a closed tubular shape, which covers the tip and side surface of a threaded portion of the bolt, into contact with the bolt temporary fixing nut, thereby sealing a portion between the opening of the rust-proofing cap and the bolt temporary fixing nut, and sealing a portion between the head of the bolt and the one surface of the one steel plate by painting. Thus, after the bolt is temporarily fixed through the bolt hole of the one steel plate of the two overlapping steel plates via the bolt temporary fixing nut, the threaded portion of the bolt can be cut off from the ambient air, and rust-proofing can be rapidly achieved by painting the lower surface of the one steel plate including the head of the bolt and by attaching the opening of the rust-proofing cap, which is to be mounted on the threaded portion of the bolt so as to cover the tip and side surface thereof, to the bolt temporary fixing nut. Moreover, the rust-proofing effect can be made to last until the rust-proofing cap is removed from the threaded portion of the bolt in order to finally fasten the nut to the bolt.

According to the fourteenth aspect of the invention, there is provided the method in which the bolt temporary fixing nut having a tapered shape, the external diameter at one end of which becomes smaller than the external diameter at the other end thereof, is threadedly attached to the bolt, which is inserted through the bolt hole of the one steel plate of the two overlapping steel plates from one surface, and the one axial end of the bolt temporary fixing nut is pushed into the gap between the bolt hole of the one steel plate and the bolt, thereby temporarily fixing the bolt and sealing a portion between an end on the side of the other surface at the inner peripheral surface of the bolt hole of the one steel plate and the bolt temporary fixing nut. Thereby, the bolt can be temporarily fixed to the bolt hole of the one steel plate in a state where its rotation is prevented by a fastening axial force onto the bolt temporary fixing nut.

According to the fifteenth aspect of the invention, there is provided the method in which the bolt to which the bolt temporary fixing nut having an external diameter larger than the bolt hole by a desired amount is threadedly attached is pushed into the bolt hole of one steel plate of the two overlapping steel plates together with the bolt temporary fixing nut from one surface of the one steel plate, thereby temporarily fixing the bolt, and sealing a portion between an end on the side of the other surface at the inner peripheral surface of the bolt hole of the one steel plate and the bolt temporary fixing nut, or the bolt to which the bolt temporary fixing nut including a locking protruding portion having an external diameter larger than the bolt hole by a desired amount is threadedly attached is pushed into the bolt hole of one steel plate of the two overlapping steel plates together with the bolt temporary fixing nut from one surface of the one steel plate until the locking protruding portion of the bolt temporary fixing nut passes through the bolt hole of the one steel plate and appears at the other surface, and then the locking protruding portion of the bolt temporary fixing nut is pushed into a gap between the bolt hole of the one steel plate and the bolt, thereby temporarily fixing the bolt, and sealing a portion between an end on the side of the other surface at the inner peripheral surface of the bolt hole of the one steel plate and the bolt temporary fixing nut. Thereby, the operation of threadedly attaching the bolt temporary fixing nut onto the bolt can be performed in a location which is different from the workplace for temporarily fixing the bolt to the one steel plate. Consequently, the working efficiency of the operation of threadedly attaching the bolt temporary fixing nut onto the bolt can be made high. In addition, the concurrent operation on both the upper and lower surfaces of the one steel plate can be made unnecessary during the operation of temporarily fixing the bolt to the bolt hole of the one steel plate. Thereby, the effect of reducing labor hour and manpower can be expected.

According to the sixteenth aspect of the invention, a rust-proofing apparatus of a fastening nut includes the bolt temporary fixing nut which can be brought into close contact with an end on the side of the other surface at the bolt hole of the one steel plate, in a state of being threadedly mounted on a threaded portion of a bolt inserted through a bolt hole of one steel plate of two overlapping steel plates which are to be joined using the bolt from one surface and a rust-proofing cap one longitudinal end of which is made into a closed tubular shape, having a body portion at one longitudinal end covering on the tip and side surface of the threaded portion of the bolt, opening at the other longitudinal end brought into contact with the bolt temporary fixing nut, and sealing a portion between the opening of the rust-proofing cap and the bolt temporary fixing nut, in which a portion between the head of the bolt and the one surface of the one steel plate can be sealed by painting. Therefore, an apparatus configuration for carrying out the rust-proofing method of a fastening bolt of the above thirteenth aspect can be realized.

According to the seventeenth aspect of the invention, a rust-proofing apparatus of a fastening nut includes a tapered portion, the external diameter of which is gradually increased from one axial end which has a smaller diameter than the bolt hole of the one steel plate of the two overlapping steel plates to the other axial end which has a larger diameter than the bolt hole of the one steel plate, and a cap attaching portion for attaching the rust-proofing cap at other axial end of the tapered portion. Thereby, the rust-proofing apparatus of a fastening bolt for carrying out the method of the fourteenth aspect can be easily realized.

According to the eighteenth aspect of the invention, the bolt temporary fixing nut is configured to include a tapered portion, the external diameter of which is gradually increased from one axial end which has a smaller diameter than the bolt hole of the one steel plate of the two overlapping steel plates to the other axial end which has a larger diameter than the bolt hole of the one steel plate, and a cap attaching portion for attaching the rust-proofing cap provided at other axial end of the tapered portion. Thereby, the attachment of the rust-proofing cap to the bolt temporary fixing nut can be easily carried out using the cap attaching portion.

According to the nineteenth aspect of the invention, a locking tapered surface portion, the inclination angle of which with respect to an axial direction increases, is provided at the other axial end of the tapered portion whose external diameter becomes larger than the bolt hole of the one steel plate by a desired amount. Thereby, the adhesiveness of the bolt temporary fixing nut to the inner peripheral surface of the upper end of the bolt hole of one steel plate can be increased, and the sealing performance between the inner peripheral surface of the upper end of the bolt hole of the one steel plate and the bolt temporary fixing nut can be further increased. In addition, it is possible to further strengthen the anti-rotational effect of the bolt which is temporarily fixed by the fastening axial force onto the bolt temporary fixing nut. Moreover, since the longitudinal position of the bolt temporary fixing nut with respect to the bolt hole of the one steel plate is determined, the fastening amount of the bolt to the bolt temporary fixing nut can be made constant.

According to the twentieth aspect of the invention, the bolt temporary fixing nut is configured to have a cap attaching portion for attaching the rust-proofing cap at one axial end of the cylindrical portion having an external diameter which is larger by a desired amount than the bolt hole of one steel plate of the two overlapping steel plates, and is pushed into the bolt hole of the one steel plate in a state of being threadedly attached to the threaded portion of the bolt, so that the bolt temporary fixing nut can be brought into close contact with and fixed to the inside of the bolt hole by the restoring force of elastic deformation which is compressed in the radial direction in the gap between the bolt hole and the bolt. Thereby, the bolt temporary fixing nut for obtaining the effects shown in the fifteenth aspect can be easily realized.

According to the twenty-first aspect of the invention, ring-shaped grooves are provided at a plurality of positions of axially desired intervals in the outer peripheral surface of the cylindrical portion of the bolt temporary fixing nut. Thereby, when the bolt temporary fixing nut threadedly attached to the threaded portion of the bolt is pushed into a bolt hole of one steel plate from one surface, annular projecting portions between the grooves adjacent to each other at the outer peripheral surface of the bolt temporary fixing nut can be elastically deformed so as to turn to the one end surface of the one steel plate. Thereafter, when the bolt is fastened to the bolt temporary fixing nut, a compressive force can be made to act on each of the annular projecting portions of the outer peripheral surface of the bolt temporary fixing nut along a direction in which the annular projecting portions are turned at the time of pushing into the bolt hole. Therefore, the bolt temporary fixing nut can be surely fixed to the inside of the bolt hole.

According to the twenty-second aspect of the invention, the bolt temporary fixing nut has a cylindrical member having a diameter which is smaller than the bolt hole of one steel plate of the two overlapping steel plates, and having an outer peripheral surface of one axial end as a cap attaching portion for attaching the rust-proofing cap, and an axial intermediate portion of the cylindrical member provided with a locking protruding portion which has a larger diameter than the bolt hole of the one steel plate, and is elastically deformable toward the axial center. Thereby, the bolt temporary fixing nut for obtaining the effects shown in the fifteenth aspect can be easily realized.

According to the twenty-third aspect of the invention, a cylindrical portion which has the same or slightly larger diameter than the bolt hole of the one steel plate of the two overlapping steel plates is provided closer to the other axial end than the locking protruding portion in the bolt temporary fixing nut. Thereby, free rotation of the bolt temporary fixing nut can be prevented in a state where the bolt temporary fixing nut threadedly attached to the threaded portion of the bolt is pushed into the bolt hole of the one steel plate from one surface, and the bolt temporary fixing nut is disposed such that the locking protruding portion appears at the other surface. In addition, since fastening of the bolt to the bolt temporary fixing nut can be made from any one surface of the one steel plate, the concurrent operation on both the upper and lower surfaces of the one steel plate can be made unnecessary during the operation of temporarily fixing the bolt to the bolt hole of the one steel plate.

According to the twenty-fourth aspect of the invention, the cap attaching portion in the bolt temporary fixing nut is made cylindrical, and the internal diameter of the opening of the rust-proofing cap is slightly smaller than the external diameter of the cap attaching portion. The opening of the rust-proofing cap is attached so as to cover the cap attaching portion of the bolt temporary fixing nut, so that the inner peripheral surface of the opening of the rust-proofing cap and the outer peripheral surface of the cap attaching portion of the bolt temporary fixing nut can be brought into close contact with each other, thereby sealing between both is easily obtained.

According to the twenty-fifth aspect of the invention, a groove is provided at an axial intermediate portion of a cylindrical cap attaching portion of the bolt temporary fixing nut. Thereby, it is possible to increase the sealing performance between the opening of the rust-proofing cap attached to the cap attaching portion and the cap attaching portion of the bolt temporary fixing nut.

### BRIEF DESCRIPTION OF THE DRAWINGS

FIG. 1 shows a steel plate joining method of the invention, and one embodiment of a bolt temporary fixing nut used for this method, and specifically, (a) is a schematic cutaway side view showing a state where a bolt is temporarily fixed to a bolt hole of a bottom steel plate, and (b) is a schematic cutaway side view showing a state where a splicing plate is joined to the bottom steel plate.

FIG. 2 shows the bolt temporary fixing nut in FIG. 1 in an enlarged manner, and specifically, (a) is a perspective view as seen from larger diameter side thereof, (b) is a cutaway side view, and (c) is a sectional view taken along a direction A-A of (b).

FIG. 3 shows another embodiment of the invention, and specifically, (a) is a schematic cutaway side view showing a state where a bolt is temporarily fixed to a bolt hole of a bottom steel plate, and (b) is a schematic cutaway side view showing a state where a splicing plate is joined to the bottom steel plate.

FIG. 4 shows a bolt temporary fixing nut in FIG. 3 in an enlarged manner, and specifically, FIG. (a) is a perspective view as seen from larger diameter side thereof, (b) is a cutaway side view, and (c) is a sectional view taken along a direction B-B of FIG. (b).

FIG. 5 is a cutaway side view showing a general connection structure between matching ends of adjacent bottom steel plates of a composite plate deck via a splicing plate.

FIG. 6 shows the outline of an example of techniques which are conventionally proposed in order to hold a bolt in a bolt hole of a bottom steel plate so as not to fall off, and specifically, (a) is a cutaway side view showing a state where the bolt is held in the bolt hole of the bottom steel plate, (b) is a cutaway side view showing a state where the splicing plate is placed on adjacent bottom steel plates, and (c) is a cutaway side view showing a state where the adjacent bottom steel plates are connected together via the splicing plate.

FIG. 7 shows one embodiment of the bolt temporary fixing nut of the invention, and specifically, (a) is a partially cutaway schematic side view, (b) is a sectional view of a portion of a thread of an internally threaded portion in a state of being threadedly attached to a threaded portion of the bolt in an enlarged manner.

FIG. 8 shows a bolt temporary fixing method performed using the bolt temporary fixing nut of FIG. 7, and specifically, (a) is a partially cutaway schematic side view showing a state where the bolt temporary fixing nut is threadedly attached to the bolt which is inserted through the bolt hole of the bottom steel plate, and (b) is a partially cutaway schematic side view showing a state where the bolt is temporarily fixed to the bolt hole of the bottom steel plate via the bolt temporary fixing nut.

FIG. 9 shows a sequence after the bolt is temporarily fixed to the bolt hole in the temporary fixing method of FIG. 8, and specifically, (a) is a partially cutaway schematic side view showing a state where painting is performed on the lower surface of the bottom steel plate, and (b) is a partially cutaway schematic side view showing a state where a splicing plate is joined to the bottom steel plate.

FIG. 10 is a partially cutaway schematic side view showing another aspect of the bolt temporary fixing nut as another embodiment of the invention.

FIG. 11 shows a bolt temporary fixing method performed using the bolt temporary fixing nut of FIG. 10, and specifically, (a) is a partially cutaway schematic side view showing a state where the bolt temporary fixing nut is threadedly attached to the bolt which is inserted through the bolt hole of the bottom steel plate, and (b) is a partially cutaway schematic side view showing a state where the bolt is temporarily fixed to the bolt hole of the bottom steel plate via the bolt temporary fixing nut.

FIG. 12 shows a sequence after the bolt is temporarily fixed to the bolt hole in the temporary fixing method of FIG. 11, and specifically, (a) is a partially cutaway schematic side view showing a state where painting is performed on the lower surface of the bottom steel plate, and a rust-proofing cap is mounted on the bolt, and (b) is a partially cutaway schematic side view showing a state where a splicing plate is joined to the bottom steel plate.

FIG. 13 is a cutaway side view showing a general connection structure between matching ends of adjacent bottom steel plates of a composite plate deck via a splicing plate.

FIG. 14 shows the outline of an example of techniques which are conventionally proposed in order to hold a bolt in a bolt hole of a bottom steel plate so as not to fall off, and specifically, (a) is a cutaway side view showing a state where the bolt is held in the bolt hole of the bottom steel plate, (b) is a cutaway side view showing a state where the splicing plate is placed on adjacent bottom steel plates, and (c) is a cutaway side view showing a state where the adjacent bottom steel plates are connected together via the splicing plate.

FIG. 15 shows the outline of another example of techniques which are conventionally proposed in order to hold a bolt in a bolt hole of a bottom steel plate so as not to fall off, and specifically, (a) is a schematic view showing a state where the bolt inserted through the bolt hole of the bottom steel plate is held by a primary nut, (b) is an outline view showing a state where a filler plate is placed above the bottom steel plate, and (c) is an outline view showing a state where the adjacent bottom steel plates are connected together via the splicing plate.

FIG. 16 shows one embodiment of the rust-proofing method and apparatus of a fastening bolt of the invention, and specifically, (a) is a partially cutaway schematic side view showing a state where the bolt is temporarily fixed to the bolt hole of the bottom steel plate via the bolt temporary fixing nut, (b) is a partially cutaway schematic side view showing a state where painting is performed on the lower surface of the bottom steel plate including a bolt head, and a rust-proofing cap is mounted on the bolt, (c) is a partially cutaway schematic side view showing a state where a splicing plate is joined to the bottom steel plate.

FIG. 17 shows the bolt temporary fixing nut in FIG. 16 in an enlarged manner, and specifically, (a) is a plan view, and (b) is a partially cutaway side view.

FIG. 18, with (a) and (b), show a modification of the bolt temporary fixing nut in FIG. 16.

FIG. 19 shows another example of the bolt temporary fixing nut as another embodiment of the invention, and specifically, (a) is a partially cutaway side view, and (b) is a partially cutaway schematic side view showing a state where rust-proofing of the threaded portion of the bolt has been performed using the bolt temporary fixing nut of (a).

FIG. 20 is a partially cutaway schematic side view showing another example of the bolt temporary fixing nut as another embodiment of the invention.

FIG. 21 shows the sequence of a rust-proofing method performed using the bolt temporary fixing nut of FIG. 20, and specifically, (a) is a partially cutaway schematic side view showing a state where the bolt temporary fixing nut is screwed onto the bolt, (b) is a partially cutaway schematic side view showing a state where the bolt is temporarily fixed to the bolt hole of the bottom steel plate via the bolt temporary fixing nut, and (c) is a partially cutaway schematic side view showing a state where painting is performed on the lower surface of the bottom steel plate including a bolt head, and a rust-proofing cap is mounted on the bolt.

FIG. 22 shows a portion of the bolt temporary fixing nut at the time of implementation of the rust-proofing method of FIG. 21 in an enlarged manner, and specifically, (a) is a cutaway side view showing a state where the bolt temporary fixing nut screwed into the bolt is pushed into the bolt hole of the bottom steel plate together with the bolt, (b) is a cutaway side view showing a state where the bolt is fastened to the bolt temporary fixing nut, and (c) is a cutaway side view showing a state where elongation has occurred in the bolt by fastening the nut, for fixing the splicing plate, to the bolt.

FIG. 23 is a partially cutaway schematic side view showing another example of the bolt temporary fixing nut as another embodiment of the invention.

FIG. 24 is a partially cutaway schematic side view showing another example of the bolt temporary fixing nut as another embodiment of the invention.

FIG. 25 shows the sequence of a rust-proofing method performed using the bolt temporary fixing nut of FIG. 24, and specifically, (a) is a partially cutaway schematic side view showing a state where the bolt temporary fixing nut is screwed onto the bolt, (b) is a partially cutaway schematic side view showing a state where the bolt is temporarily fixed to the bolt hole of the bottom steel plate via the bolt temporary fixing nut, and (c) is a partially cutaway schematic side view showing a state where painting is performed on the lower surface of the bottom steel plate including a bolt head, and a rust-proofing cap is mounted on the bolt.

FIG. 26 is a partially cutaway schematic side view showing another example of the bolt temporary fixing nut as another embodiment of the invention.

FIG. 27 shows the sequence of a rust-proofing method performed using the bolt temporary fixing nut of FIG. 26, and specifically, (a) is a partially cutaway schematic side view showing a state where the bolt temporary fixing nut is screwed onto the bolt, (b) is a partially cutaway schematic side view showing a state where the bolt is temporarily fixed to the bolt hole of the bottom steel plate via the bolt temporary fixing nut, and (c) is a partially cutaway schematic side view showing a state where painting is performed on the lower surface of the bottom steel plate including a bolt head, and a rust-proofing cap is mounted on the bolt.

FIG. 28 is a cutaway side view showing a general connection structure between matching ends of adjacent bottom steel plates of a composite plate deck via a splicing plate.

FIG. 29 shows the outline of an example of techniques which are conventionally proposed in order to hold a bolt in a bolt hole of a bottom steel plate so as not to fall off, and specifically, (a) is a cutaway side view showing a state where the bolt is held in the bolt hole of the bottom steel plate, (b) is a cutaway side view showing a state where the splicing plate is placed on adjacent bottom steel plates, and (c) is a cutaway side view showing a state where the adjacent bottom steel plates are connected together via the splicing plate.

FIG. 30 is an outline view showing a corrosion-proofing cap which is conventionally proposed as one of the solutions for performing corrosion-proofing of a threaded portion of a bolt and a nut used for the joining of two plates.

### DETAILED DESCRIPTION OF THE INVENTION

Hereinafter, the best modes for carrying out the invention will be described in detail with reference to the drawings.

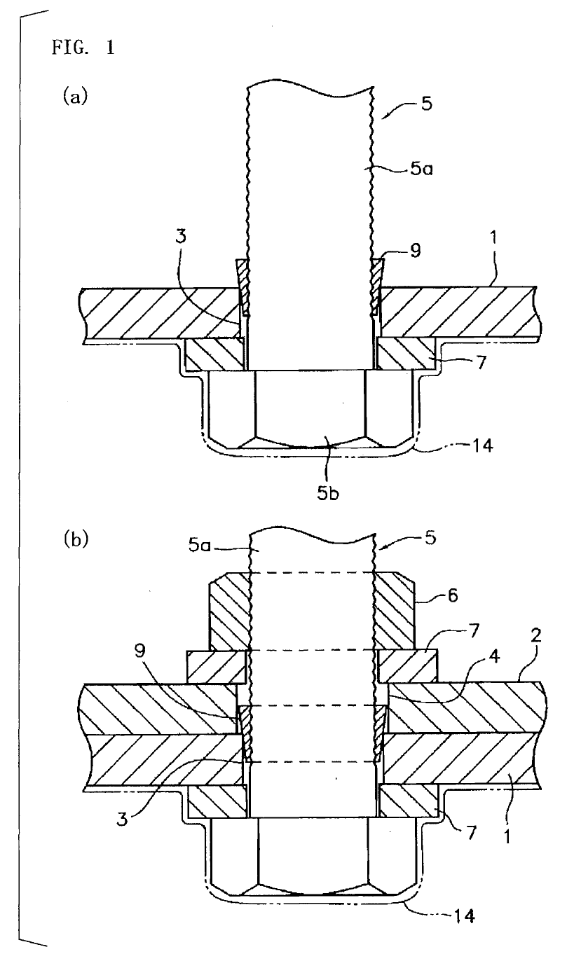

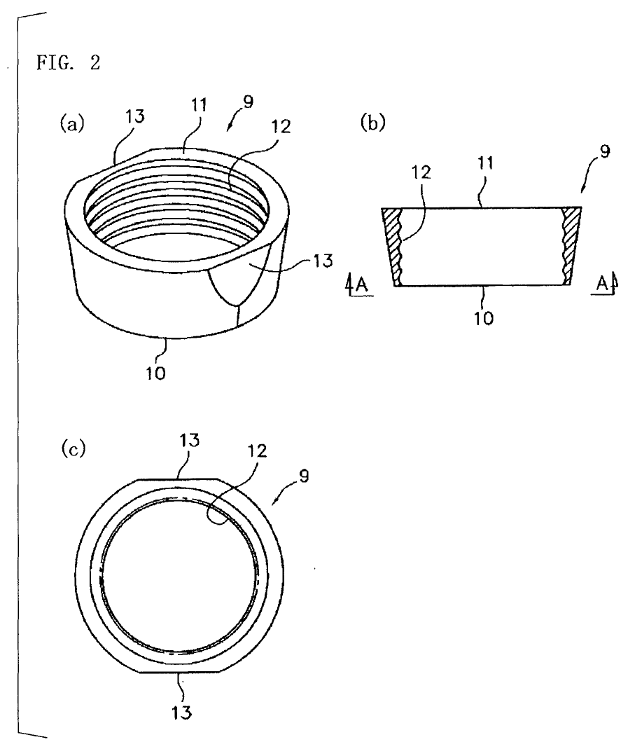

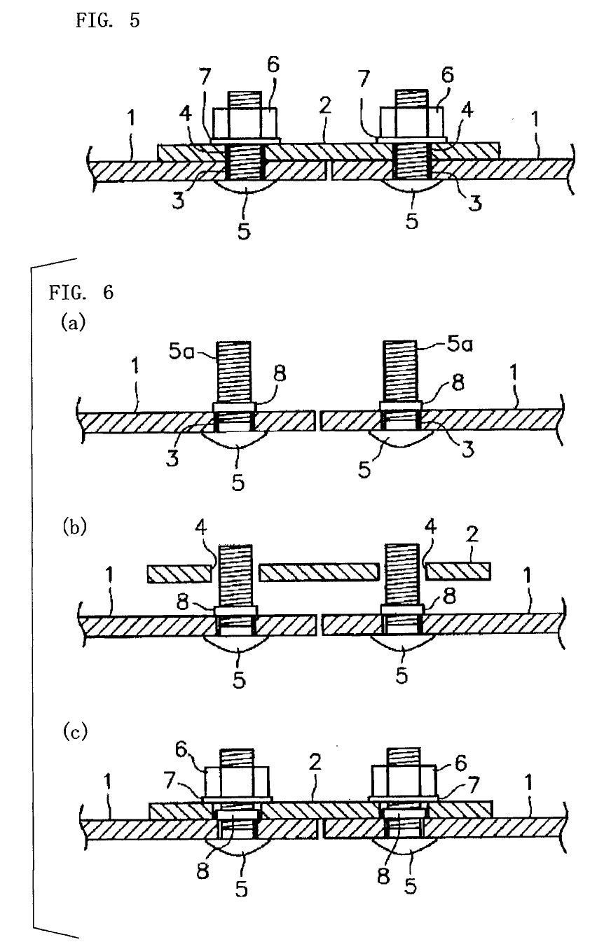

(a) and (b) of FIG. 1, and (a), (b), and (c) of FIG. 2 show a steel plate joining method of the invention, and an embodiment of a bolt temporary fixing nut to be used for the method, and show a case where the invention is applied to a junction between a bottom steel plate 1 and a splicing plate 2 of the same composite plate deck as that shown in FIG. 5, as steel plates. This embodiment is performed in the following manner.

That is, the axial length of the bolt temporary fixing nut 9 of the invention is set to an amount which is larger than the thickness of the splicing plate 2, and is slightly smaller than the sum of the thickness of the bottom steel plate 1 and the thickness of the splicing plate 2. Moreover, in the bolt temporary fixing nut 9, the external diameter of one axial end 10 is set to be smaller than a bolt hole 3 provided in the bottom steel plate 1, and the external diameter of the other axial end 11 is set to be larger than the bolt hole 3 by a desired amount. Thereby, an outer peripheral surface of the bolt temporary fixing nut 9 has a tapered shape which is gradually increased in diameter from one axial end 10 toward the other end 11.

An inner peripheral surface of the bolt temporary fixing nut 9 is provided with an internally threaded portion 12 for being threadedly attached to a shank 5a of a bolt 5 to be used for the joining between the bottom steel plate 1 and the splicing plate 2.

Moreover, one pair of axial chamfers 13 are provided in parallel in two positions which faces each other at 180 degrees on the outer peripheral surface in the vicinity of the other axial end which becomes the larger diameter side of the bolt temporary fixing nut 9. This allows a fastening tool (not shown), such as a spanner or a monkey wrench, to be hung on the one pair of chamfers 13 of the bolt temporary fixing nut 9 so that the bolt temporary fixing nut 9 can be turned using the fastening tool.

In addition, the bolt temporary fixing nut 9 is made of, for example, synthetic resin, or metal, such as brass, steel, or aluminum, which is softer than the bottom steel plate 1 and the bolt 5, so that it can allow desired elastic deformation. This allows the bolt temporary fixing nut 9 to be screwed into a gap between the bolt hole 3 and the bolt 5 by the fastening axial force onto the bolt 5 as will be described later so that the bolt temporary fixing nut 9 can be made to bite into the gap between the bolt hole 3 and the bolt 5 in a wedge shape from one axial end 10 up to a portion which is closer by a desired amount to the other axial end, which is the side with larger diameter, from a portion the diameter of which becomes equal to the bolt hole 3. Accordingly, the bolt temporary fixing nut 9 can strongly press against the inner peripheral surface in the vicinity of an upper end of the bolt hole 3 over the entire length in the peripheral direction by the restoring force of the radial compressive elastic deformation caused in a portion of the bolt temporary fixing nut 9 bitten into the gap between the bolt hole 3 and the bolt 5.

In addition, the tapered shape of the outer peripheral surface of the bolt temporary fixing nut 9 is such that, when the bolt temporary fixing nut 9 is made to bite into the gap between the bolt hole 3 and the bolt 5 in a wedge shape as described above, one end 10 on the smaller diameter side of the bolt temporary fixing nut 9 is housed inside the bolt hole 3, and the height of the other end 11 on the larger diameter side of the bolt temporary fixing nut 9, which has protruded above the bottom steel plate 1 from the upper surface of the bottom steel plate 1, is set to be smaller than the thickness of the splicing plate 2.

By joining together the bottom steel plate 1 of the composite plate deck as a steel plate and the splicing plate 2 using the bolt temporary fixing nut 9 having the above configuration, the connection between matching ends of adjacent bottom steel plates 1 via the splicing plate 2 is performed similarly to that shown in FIG. 5. In this case, in advance in a factory, etc., as shown in (a) of FIG. 1, the bolt (high tensile bolt) 5 is disposed so as to be inserted into the bolt hole 3 via a washer 7 from the bottom, and thereafter, the bolt temporary fixing nut 9 is fitted to the shank 5a of the bolt 5 from the one end 10 which becomes the small diameter side, thereby threadedly attaching the internally threaded portion 12. Thereafter, the bolt temporary fixing nut 9 is fastened to the bolt 5 using a fastening tool (not shown) hung on the one pair of chamfers 13, whereby the bolt temporary fixing nut 9 is screwed and made to bite into the gap between the bolt hole 3 and the bolt 5 in a wedge shape, utilizing the fastening axial force of the bolt temporary fixing nut 9 onto the bolt 5.

At this time, since the axial dimension of the bolt temporary fixing nut 9 is set to be a dimension which is slightly smaller than the sum of the thickness of the bottom steel plate 1 and the thickness of the splicing plate 2, the number of threads arrayed in the internally threaded portion 12 axially formed in the inner peripheral surface increases as compared with a hooking ring 8 shown in Patent Document 1 as shown in (a), (b), and (c) of FIG. 6. Thereby, since a strong fastening axial force can be made to act on the bolt 5 from the bolt temporary fixing nut 9, a large frictional force is generated between the bolt temporary fixing nut 9 and the bolt 5. Moreover, by screwing the bolt temporary fixing nut 9 using the strong fastening axial force made to act on the bolt 5, the portion of the bolt temporary fixing nut 9 which has a larger diameter than the bolt hole 3 is forcibly made to bite into the gap between the bolt hole 3 and the bolt 5 in a wedge shape. Therefore, since the bolt temporary fixing nut 9 is strongly pressed against and brought into close contact with the inner peripheral surface of the upper end of the bolt hole 3 over the entire length in the peripheral direction by the restoring force of the bolt temporary fixing nut 9 which undergoes compressive elastic deformation in the gap between the bolt hole 3 and the bolt 5, a large frictional force is also generated between the bolt temporary fixing nut 9 and the bolt hole 3. Consequently, the bolt 5 is temporarily fixed to the bolt hole 3 in a state where its rotation is prevented by the large frictional force between the bolt hole 3 and the bolt temporary fixing nut 9 and the large frictional force between the bolt temporary fixing nut 9 and the bolt 5.

Next, if necessary, in a factory, etc., as indicated by a two-dot chain line in (a) of FIG. 1, preliminary painting is performed on the whole surface including a head 5b of the bolt 5, at the lower surface of the bottom steel plate 1 which is obtained by temporarily fixing the bolt 5 to the bolt hole 3 via the bolt temporary fixing nut 9. Reference numeral 14 represents a paint film.

Thereafter, the bolt 5 is attached to the bolt hole 3 and the bottom steel plate 1 the lower surface of which is subjected to preliminary painting is carried into a construction site. Then, the bottom steel plates 1 are disposed side by side in the direction of a span on a main girder. Thereafter, the splicing plate 2, which is obtained by boring a bolt hole 4 which is larger by a desired amount than the external diameter of the other axial end 11 which becomes a larger diameter end of the bolt temporary fixing nut 9, is placed from above in a position corresponding to the bolt hole 3 of each of the bottom steel plates 1 as shown in (b) of FIG. 1 ((b) of FIG. 1 shows only one bottom steel plate 1) above the matching ends of the adjacent bottom steel plates 1 such that the bolt 5 temporarily fixed to the bolt hole 3 is inserted through the bolt hole 4 of the splicing plate 2.

Thereafter, overlapping portions of the bottom steel plate 1 and the splicing plate 2 are joined together by means of the bolt 5 by fitting the nut 6 onto the shank 5a of each bolt 5 which protrudes above the splicing plate 2 via a washer 7 and by fastening the nut 6 to the bolt 5. Thereby, the matching ends of the adjacent bottom steel plates 1 will be connected via the splicing plate 2.

As described above, according to the steel plate joining method of the invention, the axial dimension of the bolt temporary fixing nut 9 is set to be larger than the thickness of the splicing plate 2 so that the number of threads arrayed in the internally threaded portion 12 provided in the inner peripheral surface of the bolt temporary fixing nut 9 can be increased as compared with the hooking ring 8 shown in Patent Document 1 as shown in (a), (b), and (c) of FIG. 6. Accordingly, it is possible to increase the fastening axial force of the bolt temporary fixing nut 9 onto the bolt 5.

Consequently, the bolt temporary fixing nut 9 can be forcibly screwed and made to bite into the gap in a wedge shape between the bolt hole 3 and the bolt 5 inserted through the bolt hole 3 by the large fastening axial force of the bolt temporary fixing nut 9 onto the bolt 5. For this reason, the bolt 5 can be temporarily fixed to the bolt hole 3 via the bolt temporary fixing nut 9 in a state where its rotation is prevented.

Accordingly, even when the nut 6 is fastened to the bolt 5 which is temporarily fixed to the bolt hole 3 from above the splicing plate 2 in an installation site of the bottom steel plate 1, the possibility that co-rotation may occur in the bolt 5 can be prevented. For this reason, as described above, preliminary painting is performed in a factory, etc. on a region including the head 5b of the bolt 5 attached to the bolt hole 3 at the lower surface of the bottom steel plate 1. Therefore, it is possible to make the painting operation from the lower surface of the bottom steel plate 1 after the installation of the bottom steel plate 1 unnecessary, and it is possible to eliminate the operation which needs scaffolding on the downside of the bottom steel plate 1, or the operation which is performed using a vehicle for high lift work.

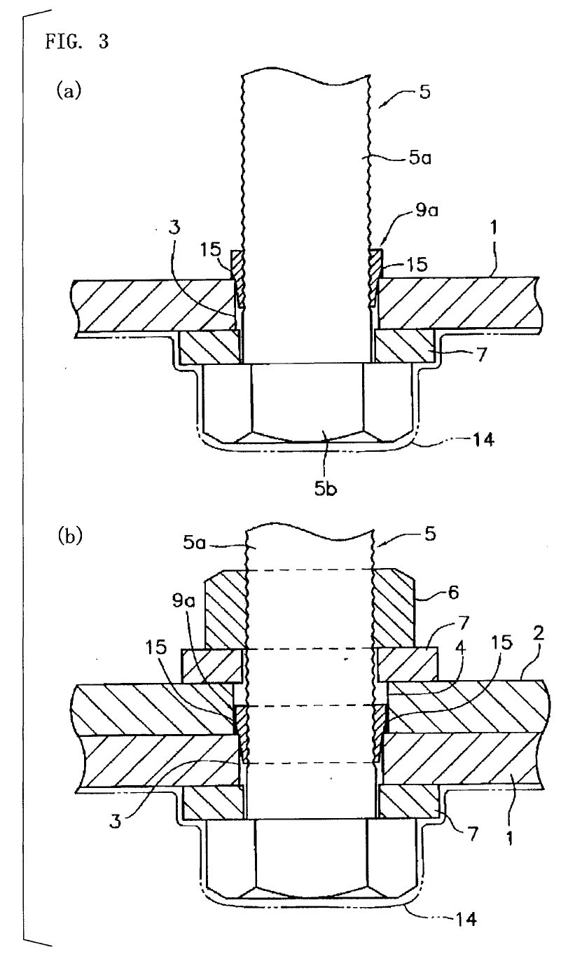

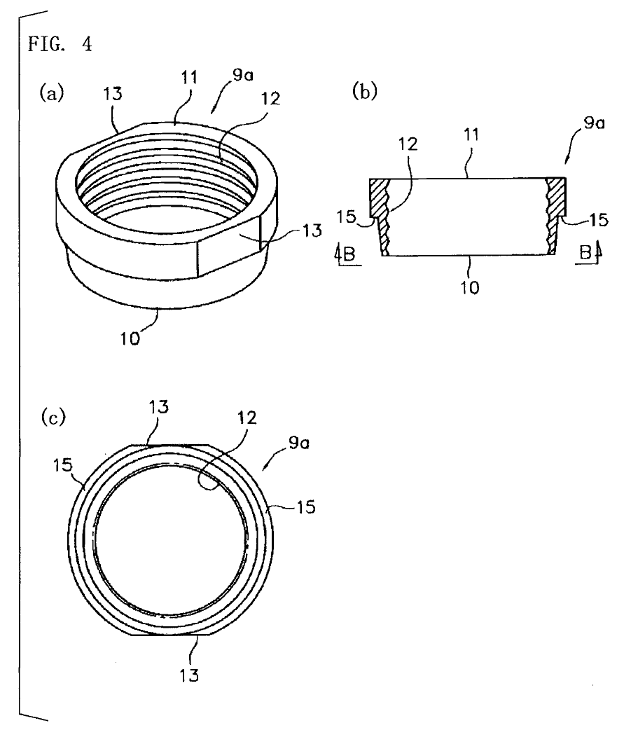

Next, (a) and (b) of FIG. 3 and (a), (b), and (c) of FIG. 4 show another embodiments of the invention. In this embodiment, in the same configuration as that shown in (a) and (b) of FIG. 1, and (a), (b), and (c) of FIG. 2, instead of configuring an outer periphery of the bolt temporary fixing nut 9 into a continuously tapered shape which is gradually increased in diameter from one axial end 10 which has a smaller diameter than the bolt hole 3 to the other axial end 11 which has a larger diameter than the bolt hole 3, a bolt temporary fixing nut 9a is configured so that a stepped surface 15 vertical to the axial direction, at the other axial end of the portion where the external diameter in the outer peripheral surface of the same tapered shape as the above tapered shape becomes slightly larger than the diameter of the bolt hole 3.

The other configurations in the bolt temporary fixing nut 9a are the same as those of the bolt temporary fixing nut 9 shown in (a) and (b) of FIG. 1, and (a), (b), and (c) of FIG. 2, and the same reference numerals are given to the same components.

In a case where the bolt temporary fixing nut 9a having the above configuration is used, in a factory, etc., as shown in (a) of FIG. 2, the bolt (high tensile bolt) 5 is disposed so as to be inserted into the bolt hole 3 via the washer 7 from the bottom, and thereafter, the bolt temporary fixing nut 9a is fitted to the shank 5a of the bolt 5 from the one end 10 which is the side of the small diameter, thereby threadedly attaching the internally threaded portion 12. Thereafter, when the bolt temporary fixing nut 9a is fastened to the bolt 5 using a fastening tool (not shown) hung on the one pair of chamfers 13 formed in the outer peripheral surface in the vicinity of the other axial end 11 which is the side of the larger diameter, the bolt temporary fixing nut 9a is screwed into the gap between the bolt hole 3 and the bolt 5, utilizing the fastening axial force of the bolt temporary fixing nut 9a onto the bolt 5, similarly to the bolt temporary fixing nut 9 in the above embodiment.

At this time, in the bolt temporary fixing nut 9a in this embodiment, the stepped surface 15 vertical to the axial direction is provided at the other axial end of the portion where the external diameter in the outer peripheral surface becomes slightly larger than the diameter of the bolt hole 3. Therefore, when the stepped surface 15 contacts an outer peripheral edge of the bolt hole 3 in the upper surface of the bottom steel plate 1, the bolt temporary fixing nut 9a is no longer screwed into the gap between the bolt hole 3 of the bottom steel plate and the bolt 5. Therefore, the resistance, when the bolt temporary fixing nut 9a is fastened by a fastening tool, becomes large abruptly.

Accordingly, an operator is able to confirm that the bolt temporary fixing nut 9a has been screwed into the gap between the bolt hole 3 and the bolt 5 up to a portion which has a larger diameter than the bolt hole 3 by a desired amount through the feeling that the resistance, when the bolt temporary fixing nut 9a is fastened, increases abruptly as described above.

Moreover, at this time, the stepped surface provided in the bolt temporary fixing nut 9a is brought into close contact with the outer peripheral edge of the bolt hole 3 in the upper surface of the bottom steel plate 1. Therefore, it is possible to further strengthen the anti-rotational effect of the bolt 5 which is temporarily fixed to the bolt hole 3 via the bolt temporary fixing nut 9a by the frictional force caused in the closely contacted portion.

As described above, after the bolt 5 is temporarily fixed to the bolt hole 3 via the bolt temporary fixing nut 9a, similarly to the above embodiment, it is only necessary to perform the joining between the bottom steel plate 1 and the splicing plate 2 by performing painting at the lower surface of the bottom steel plate 1, then overlapping the splicing plate 2 over the bottom steel plate 1 in an installation site of the bottom steel plate 1, and then fastening the nut 6 to the bolt 5.

In addition, the invention is not limited only to the embodiments. For example, the inclination angle to the axial direction of the portion having the tapered shape in the outer periphery of each of the bolt temporary fixing nuts 9 and 9a may be suitably changed according to the thickness of the bottom steel plate 1 and the splicing plate which are to be joined together, or the size of the gap between the bolt 5 and the bolt hole 3 provided in one steel plate to allow the bolt 5 to be attached thereto in advance.

The steel plate joining method of the invention may be applied to a joining spot between the bottom steel plate 1 and the splicing plate 2 when painting is not required on the side of the lower surface of the bottom steel plate 1. Moreover, when two steel plates are joined using bolts, the steel plate joint method of the invention may be applied to a joining spot between any steel plates other than the bottom steel plate 1 and the splicing plate 2 as long as the joining spot is a spot which is desired to attach a bolt to a bolt hole provided in one steel plate so as not to fall off in advance.

Hereinafter, other best modes for carrying out the invention will be described in detail with reference to the drawings.

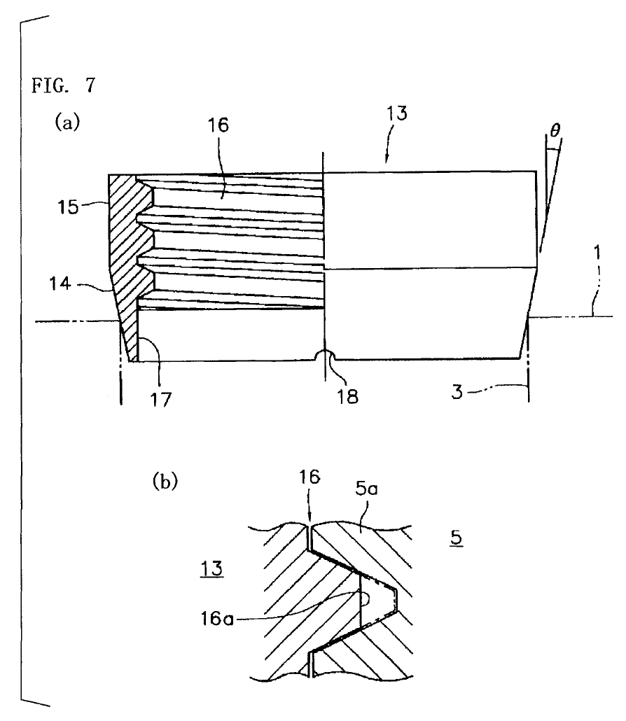

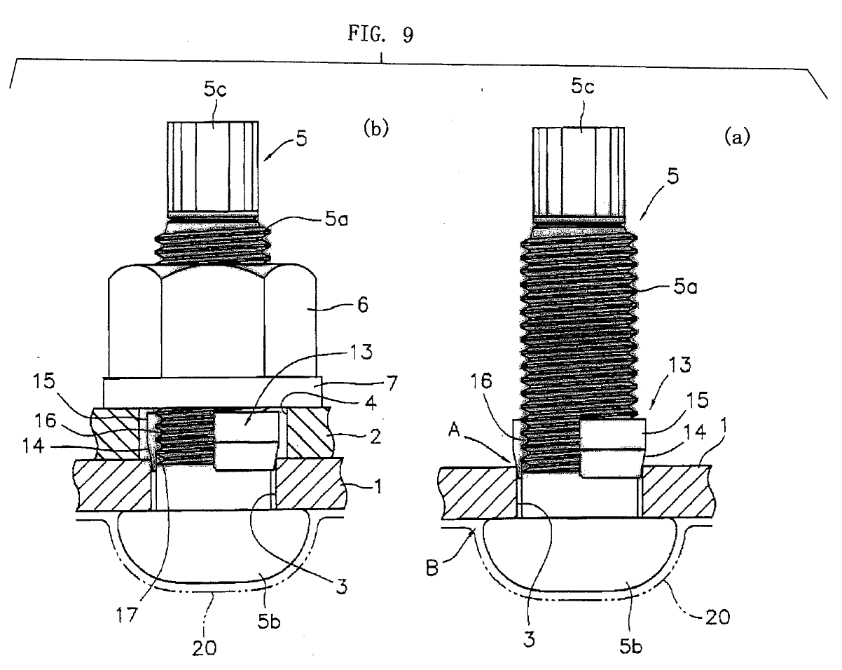

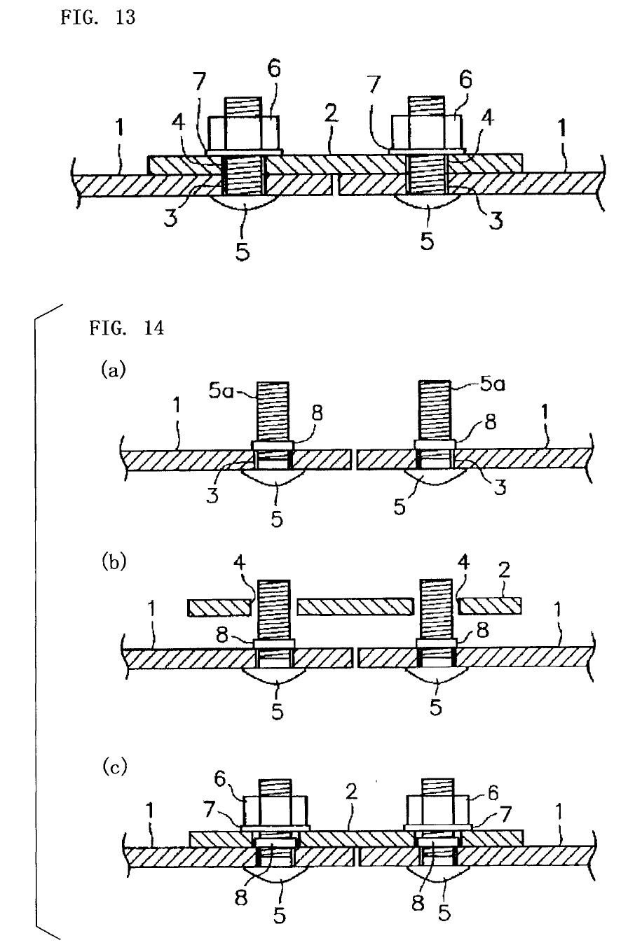

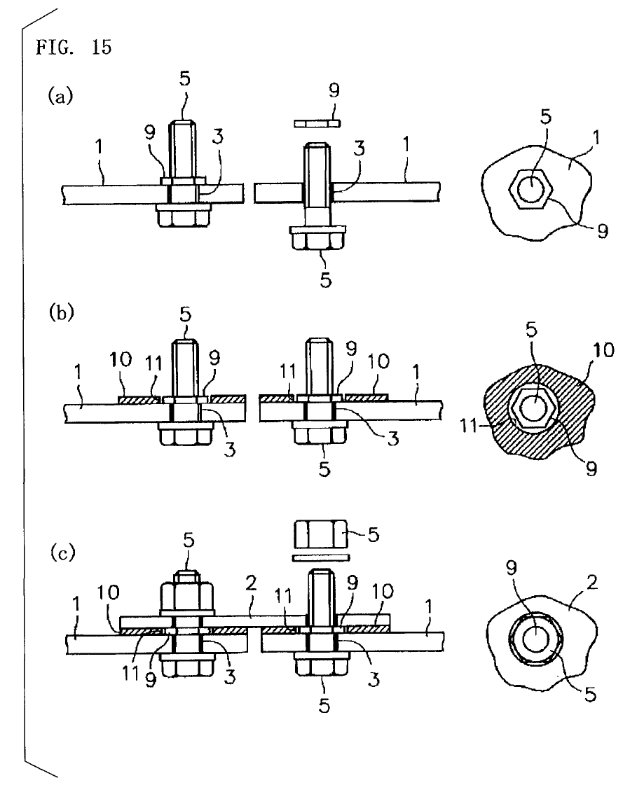

(a) and (b) of FIG. 7 to (a) and (b) of FIG. 9 show a bolt temporary fixing nut of the invention, and one embodiment of a temporary fixing method of a bolt using the bolt temporary fixing nut, and shows a case where the high tensile bolt 5, which is to be used for the joining between overlapping portions of the bottom steel plates 1 and the splicing plate 2 of the same composite plate deck as that shown in FIG. 13 as an example of the overlapping portions between steel plates, is temporarily fixed to the bolt hole 3. This embodiment is performed in the following manner.

That is, the bolt temporary fixing nut 13 of the invention, as its basic configuration is shown in (a) and (b) of FIG. 7, is configured such that a tapered portion 14 whose outer peripheral surface is inclined at a desired angle θ with respect to the axial direction such that its diameter is gradually reduced toward one axial end which has a smaller diameter than the bolt hole 3 by a desired amount is integrally provided at one axial end of a cylindrical portion 15 which extends by a desired amount in the axial direction with an external diameter which is larger by a desired amount than the bolt hole 3 provided in the bottom steel plate 1. In addition, one axial end of the cylindrical portion 15 does not mean the end of the cylindrical portion 15. The tapered portion 14 can exist in any axial position of the cylindrical portion 15.

In addition, an inner peripheral surface of the bolt temporary fixing nut 13 is provided with an internally threaded portion 16 for being threadedly attached to the threaded portion 5a of the bolt 5.

Moreover, the axial dimension of the bolt temporary fixing nut 13, as will be described later, is set such that the other axial end of the cylindrical portion 15 which is the other axial end of the bolt temporary fixing nut 13 protruding from the upper surface of the bottom steel plate 1 is equal to or less than the thickness of the splicing plate 2, when a fastening axial force is made to act between the bolt 5 inserted through the bolt hole 3 from the lower surface and the bolt temporary fixing nut 13 threadedly attached to the threaded portion 5a of the bolt 5, and thereby one end of the tapered portion 14 of the bolt temporary fixing nut 13 has been made to bite into the gap between the bolt hole 3 and the bolt 5. In addition, in a case where the washer 7, which has a larger internal diameter than the external diameter of the cylindrical portion of the bolt temporary fixing nut 13, is used as the washer 7 fitted on the high tensile bolt 5 at the time of the joining between the bottom steel plate 1, to which the high tensile bolt 5 is temporarily fixed using the bolt temporary fixing nut 13 and the splicing plate 2 placed on the steel plate, the axial dimension of the bolt temporary fixing nut may be set such that the dimension when the other axial end of the bolt temporary fixing nut 13 protruding from the upper surface of the bottom steel plate 1 is equal to or less than the sum of the thickness of the splicing plate 2 and the thickness of the washer 7, in a state where a fastening axial force is made to act between the bolt 5 inserted through the bolt hole 3 and the bolt temporary fixing nut.

The bolt temporary fixing nut 13 is made of metal, such as steel, brass, or aluminum, which is softer than the bottom steel plate 1 and the bolt 5, and more preferably made of synthetic resin, so that it can allow desired elastic deformation. Thereby, one axial end which is the tip side of the tapered portion 14 of the bolt temporary fixing nut 13 is made to bite into the gap between the bolt hole 3 and the bolt 5 by the fastening axial force between the bolt 5 inserted through the bolt hole 3 from the bottom and the bolt temporary fixing nut 13. Thereby, the outer peripheral surface of the tapered portion 14 of the bolt temporary fixing nut 13 can be brought into close contact with the inner peripheral surface of the upper end in the bolt hole 3 by the restoring force of elastic deformation which is compressed in the thickness direction (radial direction) caused in the portion in the tapered portion 14 of the bolt temporary fixing nut 13 which has bitten between the bolt hole 3 and the bolt 5. Thus, the anti-loosening effect of the bolt temporary fixing nut 13 can be obtained, and the sealing performance between the bolt hole 3, and the bolt temporary fixing nut 13 can be obtained.

Moreover, if the bolt temporary fixing nut 13 is made of a synthetic resin, the outer periphery of the tapered portion 14 can be more surely brought into close contact with the inner peripheral surface of the upper end in the bolt hole 3. Therefore, it is possible to enhance the anti-loosening effect of the bolt temporary fixing nut 13, and it is possible to further increase the sealing performance between the bolt hole 3 and the bolt temporary fixing nut 13. Moreover, it is possible to easily mold the bolt temporary fixing nut 13 having the shape of the outer peripheral surface composed of the tapered portion 14 and the cylindrical portion 15, and the complicated shape of the inner peripheral surface provided with the internally threaded portion 16. Consequently, it is possible to make the bolt temporary fixing nut 13 advantageous to mass production, and it is possible to make the unit price low. Moreover, it is preferable to make the bolt temporary fixing nut 13 of a synthetic resin which does not corrode so as not to affect the robustness of the bolt 5 from the point that the bolt temporary fixing nut 13 is exposed to the ambient air in a state where the bolt 5 is temporarily fixed to the bolt hole 3, and, as will be described later in (b) of FIG. 9, even from the point that the bolt temporary fixing nut 13 remains mounted on the threaded portion 5a of the bolt 5 even after the splicing plate 2 is placed on the bottom steel plate 1, and the nut 6 is finally fastened to the bolt 5 from above the splicing plate 2, thereby joining the bottom steel plate 1 and the splicing plate 2.

When the bolt temporary fixing nut 13 is made of a synthetic resin, as described above, and the cross-sectional shape of which is shown in (b) of FIG. 7, a thread 16a of the internally threaded portion 16 of the inner peripheral surface has a shape obtained by cutting the apex of a normal thread shape as indicated by a one-dot chain line in (b) of FIG. 7. Thereby, as shown in (b) of FIG. 7, as the apex of the thread of the threaded portion 5a of the bolt 5 contacts the portion of a valley (thread groove) of the internally threaded portion 16, the fastening axial force generated by the bolt 5 and the bolt temporary fixing nut 13 can be sufficiently secured. Also, as the portion where the thickness in the peripheral wall of the bolt temporary fixing nut 13 changes abruptly is reduced, the possibility of occurrence of shrinkage can be reduced at resin molding at the time of the manufacture of the bolt temporary fixing nut 13, so that the bolt temporary fixing nut 13 can be manufactured with high precision.

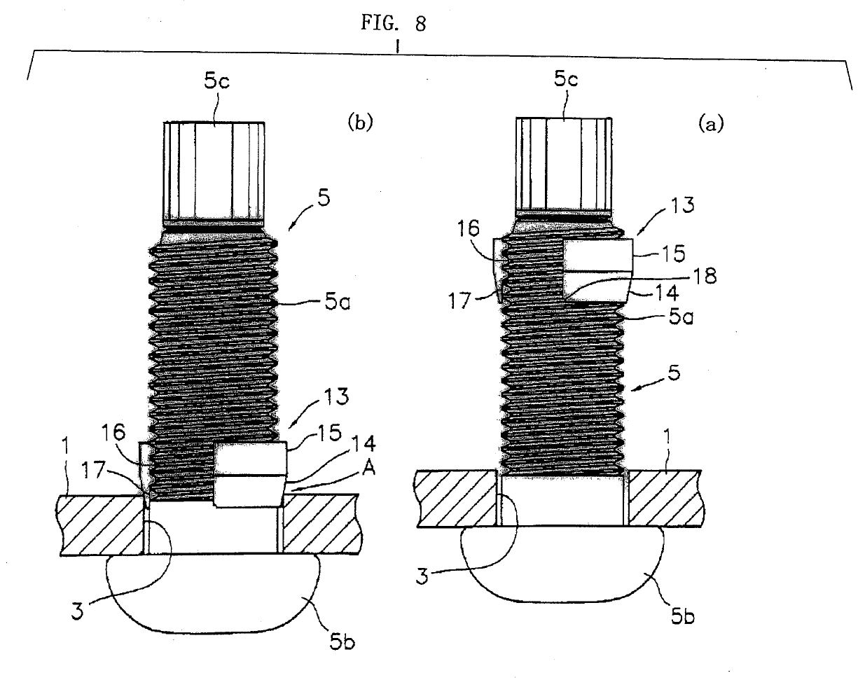

Moreover, a thread-less portion 17 with no thread of the internally threaded portion 16 is provided in the inner peripheral surface without a range of desired length at one axial end which is the tip side of the tapered portion 14 of the bolt temporary fixing nut 13. Thereby, as shown in (b) of FIG. 8, even in a case where a region where no thread is engraved or an incomplete threaded portion exists in the under-head portion in the vicinity of the head 5b of the bolt 5 ((b) of FIG. 8 shows a case where a region where no thread is engraved exists in the under-head portion of the bolt 5), the bolt temporary fixing nut 13 threadedly attached to the threaded portion 5a of the bolt 5 can be screwed into the position where the thread-less portion 17 provided in the inner peripheral surface of one axial end of the bolt temporary fixing nut 13 covers the outer periphery of the region where no thread is engraved or an incomplete threaded portion in the under-head portion of the bolt 5. Thus, the fastening axial force onto the bottom steel plate 1 can be surely made to act between the head 5b of the bolt 5 inserted through the bolt hole 3 and the tapered portion 14 of the bolt temporary fixing nut 13 threadedly attached to the threaded portion 5a of the bolt 5.

Furthermore, a mark 18 by making a cutout, etc. is provided in any one axial end in the bolt temporary fixing nut 13. (a) of FIG. 7 shows, as an example, a state where the mark 18 by a semicircular cutout is provided on a peripheral wall of one axial end which is a tip portion of the tapered portion 14. Since this allows the tapered portion 14 of the bolt temporary fixing nut 13 which has a substantially cylindrical shape whose wall thickness is small as a whole to be distinguished at a glance, as will be described later, the efficiency of the operation of threadedly attaching the bolt temporary fixing nut 13 to the threaded portion 5a of the bolt 5 from one axial end which is the tip side of the tapered portion 14 can be enhanced.

After the bolt temporary fixing nut 13 is fixed by the same method as the previous best modes, as indicated by a two-dot chain line in (a) of FIG. 9, preliminary painting, if necessary, is performed in a factory, etc. on the whole surface including the head 5b of the high tensile bolt 5, at the lower surface of the bottom steel plate 1 which is obtained by temporarily fixing the high tensile bolt 5 to the bolt hole 3 via the bolt temporary fixing nut 13. Reference numeral 20 represents a paint film. Thereby, a portion (spot B in the drawing) between the head 5b of the high tensile bolt 5 and the lower surface of the bottom steel plate 1 is sealed.

Thereafter, the bottom steel plate 1 in which the high tensile bolt 5 is attached to the bolt hole 3 in the above manner is carried into a construction site. Then, the bottom steel plates 1 are disposed side by side in the direction of a span on a main girder. Thereafter, the splicing plate 2 which is obtained by boring a bolt hole 4 which is larger by a desired amount than the cylindrical portion 15 of the bolt temporary fixing nut 13 is placed in a position corresponding to the bolt hole 3 of each of the bottom steel plates 1 as shown in (b) of FIG. 9 ((b) of FIG. 9 shows only one bottom steel plate 1) above the matching ends of the adjacent bottom steel plates 1 from the top such that the high tensile bolt 5 temporarily fixed to the bolt hole 3 is inserted through the bolt hole 4 of the splicing plate 2.

Thereafter, overlapping portions of the bottom steel plate 1 and the splicing plate 2 are joined together by means of the high tensile bolt 5 by fitting the nut 6 onto the threaded portion 5a of each high tensile bolt 5 which protrudes above the splicing plate 2 via a washer 7, and by fastening the nut 6 to the high tensile bolt 5. Thereby, the matching ends of the adjacent bottom steel plates 1 will be connected via the splicing plate 2.

Moreover, since the bolt temporary fixing nut 13 is configured such that the cylindrical portion 15 is provided at the other axial end of the tapered portion 14, the external diameter of the bolt temporary fixing nut 13 can be made relatively small, and the diameter of the bolt hole 4 provided in a bolt insertion portion of the splicing plate 2 can be made small. Moreover, the splicing plate 2 can be placed on and joined to the bottom steel plate 1 without a filler plate. Consequently, it is possible to secure the robust frictional joining between the bottom steel plate 1 and the splicing plate 2.

In addition, by providing the bolt temporary fixing nut 13 with the cylindrical portion 15, it is possible to reduce a thin-walled portion and to suppress the change of the wall thickness in the axial direction. Thus, it is possible to secure the strength as a nut capable of making a large fastening axial force act between the high tensile bolt 5 and the bolt temporary fixing nut.

Moreover, the high tensile bolt 5 can be temporarily fixed to the bolt hole 3 in a state where its rotation is prevented by a large fastening axial force onto the bolt temporary fixing nut 13 fixed to the inside of the bolt hole 3.

For this reason, even when the nut 6 is fastened to the high tensile bolt 5 which is temporarily fixed to the bolt hole 3 from above the splicing plate 2 in an installation site of the bottom steel plate 1, co-rotation in the high tensile bolt 5 can be prevented.

Consequently, as described above, preliminary painting is performed in a factory, etc. on a region including the head 5b of the high tensile bolt 5 attached to the bolt hole 3 at the lower surface of the bottom steel plate 1. Therefore, it is possible to make unnecessary the painting operation from the lower surface of the bottom steel plate 1 after installation thereof unnecessary, and it is possible to eliminate the operation which needs scaffolding on the downside of the bottom steel plate 1, or the operation which is performed using a vehicle for high lift work.

In addition, at the time of the temporarily fixing of the high tensile bolt 5, the bolt temporary fixing nut 13 is made to bite into the gap between the bolt hole 3 and the bolt 5 from one axial end which is the tip side of the tapered portion 14. Therefore, as the peripheral wall of the tapered portion 14 of the bolt temporary fixing nut 13 is interposed between the inner peripheral surface of the upper end of the bolt hole 3 and the threaded portion 5a of the high tensile bolt 5, the center of the bolt hole 3 and the center of the high tensile bolt 5 can be made to coincide with each other.

Moreover, when the high tensile bolt 5 is temporarily fixed to the bolt hole 3, the outer peripheral surface of the tapered portion 14 of the bolt temporary fixing nut 13 is strongly brought into close contact with the inner peripheral surface of the upper end of the bolt hole 3 over the entire length in the peripheral direction, and a portion (spot A in (b) of FIG. 8) between the bolt temporary fixing nut 13 and the inner peripheral surface of the upper end of the bolt hole 3 is sealed. Therefore, even if the period to the installation of the bottom steel plate 1 is vacant in a state where the high tensile bolt 5 is temporarily fixed to the bolt hole 3 using the bolt temporary fixing nut 13, it is possible to suppress entering of moisture into the bolt hole 3, and to suppress the possibility that rust may occur in the threaded portion 5a of the high tensile bolt 5, which is located inside the bolt hole 3. Moreover, as indicated by a two-dot chain line in (a) of FIG. 9, preliminary painting is performed at the lower surface of the bottom steel plate 1 including the head 5b of the high tensile bolt 5, and thus, a portion (spot B in (a) of FIG. 9) between the head of the high tensile bolt 5 and the lower surface of the bottom steel plate 1 is sealed by the paint film 20. Thereby, it is possible enhance the rust-proofing effect of the portion in the threaded portion 5a of the high tensile bolt 5, which is located inside the bolt hole 3.

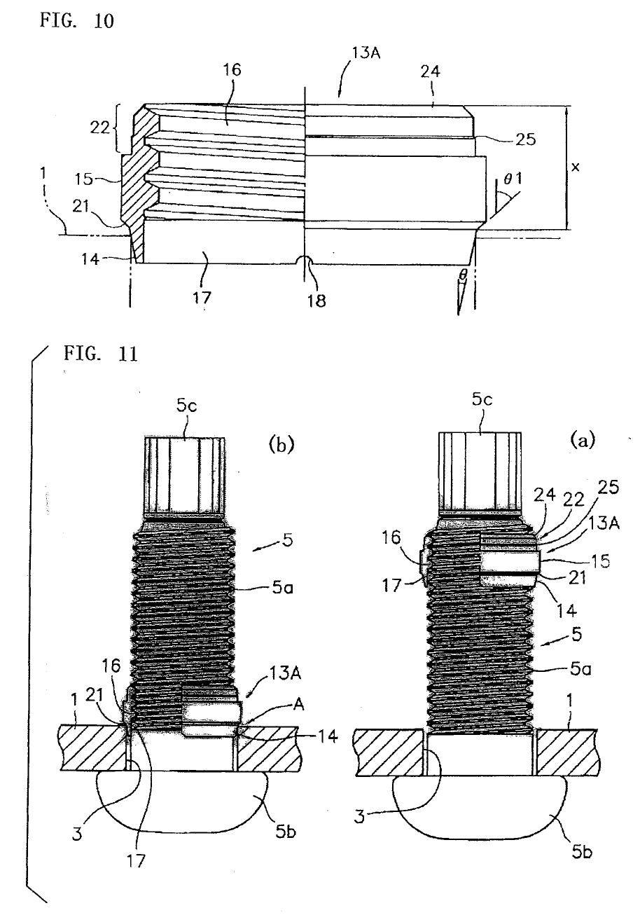

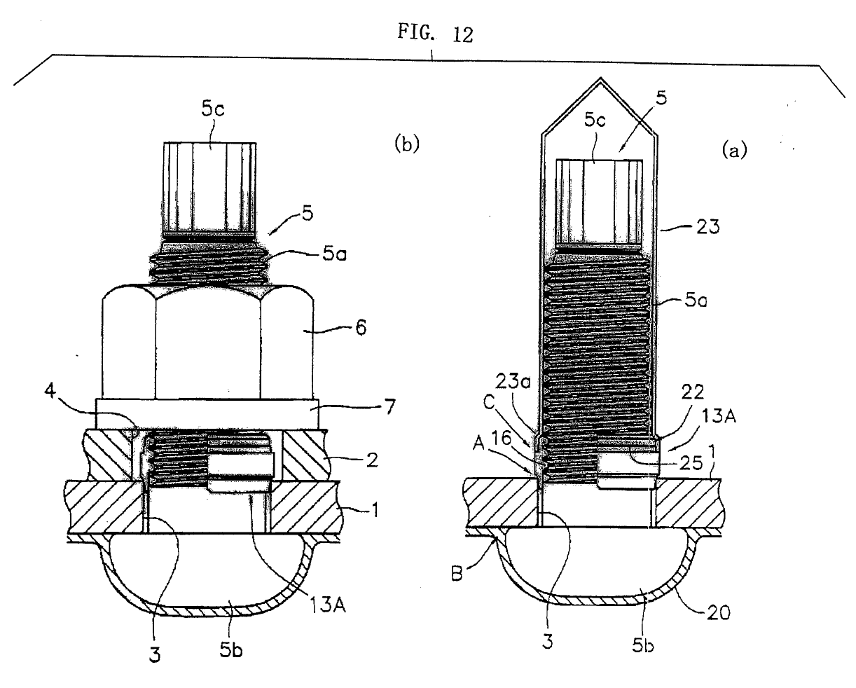

Next, FIG. 10 to (a) and (b) of FIG. 12 show an application of the embodiment of (a) and (b) of FIG. 7 to (a) and (b) of FIG. 9, as another embodiment of the invention. This embodiment is performed as follows.

FIG. 10 shows a bolt temporary fixing nut 13A of this embodiment. In the bolt temporary fixing nut 13A, in the same configuration as the bolt temporary fixing nut 13 shown in (a) and (b) of FIG. 7, instead of configuring the outer peripheral surface of the tapered portion 14 into a continuously tapered shape which is gradually increased in diameter from one axial end which has a smaller diameter than the bolt hole 3 to the other axial end which has a larger diameter than the bolt hole 3, a bolt temporary fixing nut 13a is configured by providing a locking tapered surface 21, in which an inclination angle θ1 with respect to the axial direction is changed so as to become larger toward the other axial end, on the side of the other axial end of the portion of the same tapered shape as the above tapered shape where the external diameter in the outer peripheral surface is slightly larger than the diameter of the bolt hole 3.

Moreover, a cap attaching portion 22 is provided at the other axial end in the cylindrical portion 15 of the bolt temporary fixing nut 13A. Thereby, as will be described later referring to (a) of FIG. 12, an opening 23a of a rust-proofing cap 23 for covering the tip side and periphery of the threaded portion 5a of the high tensile bolt 5 which is temporarily fixed to the bolt hole 3 using the bolt temporary fixing nut 13A is covered on and attached to the outer periphery of the cap attaching portion 22, so that a portion between the opening 23a of the rust-proofing cap 23 and the cap attaching portion 22 of the bolt temporary fixing nut 13A can be sealed.

The cap attaching portion 22 is such that its external diameter is smaller than the external diameter of the cylindrical portion 15 by a desired amount. This makes it possible to make small the external diameter of the opening 23a of the rust-proofing cap 23 for being covered on and attached to the outer periphery of the cap attaching portion 22. Consequently, even in a case where the dimensional difference between the internal diameter of the bolt hole 4 of the splicing plate 2 placed on and joined to the bottom steel plate 1 and the external diameter of the cylindrical portion 15 of the bolt temporary fixing nut 13A is small, it is possible to obtain a configuration which is advantageous when the high tensile bolt 5 which is temporarily fixed to the bolt hole 3 is inserted through the bolt hole 4 of the splicing plate 2 with the rust-proofing cap 23 thereon.

Moreover, an outer peripheral portion of the other axial end which is a tip of the cap attaching portion 22 is provided with a tapered portion 24 whose corner is chamfered. This makes it possible to smoothly perform the operation of covering and attaching the opening 23a of the rust-proofing cap 23 on the outer periphery of the cap attaching portion 22.

In addition, a desired stepped portion 25 is provided at an axial intermediate portion of the cap attaching portion 22 over the entire length in the peripheral direction. Thereby, when the opening 23a of the rust-proofing cap 23 is covered on and attached to the outer periphery of the cap attaching portion 22, portions having high adhesiveness between the inner peripheral surface of the opening 23a of the rust-proofing cap 23 and the outer peripheral surface of this cap attaching portion 22 are formed in two spots in direction across the position of the cap attaching portion 22 corresponding to the stepped portion 25, so that the sealing performance between the opening 23a of the rust-proofing cap 23 and the cap attaching portion 22 of the bolt temporary fixing nut 13A can be further increased by the labyrinth effect.

The axial dimension of the bolt temporary fixing nut 13A is set such that the length x from one axial end of the locking tapered surface 21 to the other axial end which is the tip of the cap attaching portion 22 is equal to or less than the thickness of the splicing plate 2. In addition, in a case where a washer 7 which has a larger internal diameter than the external diameter of the cylindrical portion 15 of the bolt temporary fixing nut 13A is used as the washer 7 fitted to the bolt 5 when the bottom steel plate 1 and the splicing plate 2 are joined together, the axial dimension of the bolt temporary fixing nut may be set such that the length x becomes an amount equal to or less than the sum of the thickness of the splicing plate 2 and the thickness of the washer 7.

Other configurations are the same as those shown in (a) and (b) of FIG. 7, and the same reference numerals are given to the same components.

At this time, in the tapered portion 14 of the bolt temporary fixing nut 13A in this embodiment, the locking tapered surface 21 where the inclination angle θ1 with respect to the axial direction becomes large is provided at the other axial end of the portion where the external diameter in the outer peripheral surface becomes slightly larger than the diameter of the bolt hole 3. Therefore, when the locking tapered surface 21 reaches the upper end of the bolt hole 3, the force which bites into the gap between the bolt hole 3 and the high tensile bolt 5 becomes large. For this reason, since the adhesiveness of the bolt temporary fixing nut 13A to the inner peripheral surface of the upper end of the bolt hole 3 increases, the sealing performance between the inner peripheral surface of the upper end of the bolt hole 3 and the bolt temporary fixing nut 13A (portion A in (c) of FIG. 11) is further increased. In addition, it is possible to further strengthen the anti-rotational effect of the bolt 5 which is temporarily fixed by the fastening axial force onto the bolt temporary fixing nut 13A.

Moreover, since the longitudinal position of the bolt temporary fixing nut 13A with respect to the bolt hole 3 is determined, the fastening amount of the high tensile bolt 5 to the bolt temporary fixing nut 13A can be made constant. Moreover, even in a case where the bolt hole 3 is slightly larger than a designed dimension, the portion of the locking tapered surface 21 of the bolt temporary fixing nut 13A can be made to bite into the gap between the bolt hole 3 and the bolt 5 in a wedge shape. Therefore, the bolt 5 can be reliably fixed in a state where its rotation is prevented by the fastening axial force onto the bolt temporary fixing nut 13A.

After the high tensile bolt 5 is temporarily fixed to the bolt hole 3 in a state where its rotation is prevented as described above, if necessary, as shown in (a) of FIG. 12, preliminary painting is performed in a factory, etc. on the whole surface including a head 5b of the bolt 5, at the lower surface of the bottom steel plate 1 which is obtained by temporarily fixing the high tensile bolt 5 to the bolt hole 3 via the bolt temporary fixing nut 13A. Reference numeral 20 represents a paint film. Thereby, a portion (spot B in the drawing) between the head 5b of the high tensile bolt 5 and the lower surface of the bottom steel plate 1 is sealed.

Moreover, the opening 23a of the rust-proofing cap 23 covered from the tip side on the threaded portion 5a of the high tensile bolt 5 which is temporarily fixed to the bolt hole 3 via the bolt temporary fixing nut 13A is covered on and attached to the outer periphery of the cap attaching portion 22 of the bolt temporary fixing nut 13A, thereby sealing a portion (spot C in (a) of FIG. 12) between the opening 23a of the rust-proofing cap 23 and the bolt temporary fixing nut 13A.

From the above, as the three spots A, B, and C in the drawings are sealed, contact of the threaded portion 5a of the high tensile bolt 5 with the ambient air can be cut off. Therefore, the rust-proofing of the threaded portion 5a of the bolt 5 is achieved.

Thereafter, the bottom steel plate 1 in which the high tensile bolt 5, which is rust-proofed, is attached to the bolt hole 3 in the above manner is carried into a construction site. Then, the bottom steel plates 1 are disposed side by side in the direction of a span on a main girder. Thereafter, the splicing plate 2 which is obtained by boring a bolt hole 4 which is larger by a desired amount than the external diameter of the cylindrical portion 15 of the bolt temporary fixing nut 13A is placed from the top in a position corresponding to the bolt hole 3 of each of the bottom steel plates 1 similarly to that shown in (b) of FIG. 9, as shown in (b) of FIG. 12 ((b) of FIG. 12 shows only one bottom steel plate 1), above the matching ends of the adjacent bottom steel plates 1 such that the high tensile bolt 5 temporarily fixed to the bolt hole 3 is inserted through the bolt hole 4 of the splicing plate 2. Thereafter, the rust-proofing cap 23 which is mounted on the threaded portion 5a of each high tensile bolt 5 which protrudes above the splicing plate 2 is pulled out. Then, overlapping portions of the bottom steel plate 1 and the splicing plate 2 are joined together by means of the high tensile bolt 5 by fitting the nut 6 onto the threaded portion 5a of each high tensile bolt 5 via the washer 7, and by fastening the nut 6 to the high tensile bolt 5. Thereby, the matching ends of the adjacent bottom steel plates 1 will be connected via the splicing plate 2.

As described above, the same effects as the embodiment of (a) and (b) of FIG. 7 through (a) and (b) of FIG. 9 can be obtained by this embodiment.

Moreover, it is possible to seal the three spots A, B, and C in (a) of FIG. 12 to cut off the threaded portion 5a of the high tensile bolt 5 from the contact with ambient air, thereby achieving rust-proofing.

In addition, the invention is not limited only to the above embodiment. The outer peripheral surface of the cylindrical portion 15 of the bolt temporary fixing nut 13, 13A may have a shape where the other end is made slightly larger than one axial end.

In a case where a whole thread bolt is used as the bolt 5 used for the joining between the bottom steel plate 1 and the splicing plate 2, the thread-less portion 17 in the inner peripheral surface of one axial end of the bolt temporary fixing nut 13 or 13A is unnecessary. Therefore, the internally threaded portion 16 may be provided in the inner peripheral surface of the bolt temporary fixing nut 13, 13A over the total length in the axial direction.

The bolt temporary fixing nut 13, 13A may be used for temporarily fixing bolts of types other than a torque-shear-type high tensile bolt 5, such as a hexagonal bolt.

The tapered portion 14 of the bolt temporary fixing nut 13 in the embodiment of (a) and (b) of FIG. 7 to (a) and (b) of FIG. 10 may have the same shape as the tapered portion 14 equipped with the locking tapered surface 21 in the bolt temporary fixing nut 13A shown in FIG. 10.

The tapered portion 14 of the bolt temporary fixing nut 13A in the embodiment of FIG. 10 to (a) and (b) of FIG. 12 may have the same shape as the tapered portion 14 of the bolt temporary fixing nut 13 of (a) and (b) of FIG. 7 with no locking tapered surface 21.

The bolt temporary fixing method using the bolt temporary fixing nut of the invention may be applied to a joining position between the bottom steel plate 1 and the splicing plate 2 when painting is not required on the side of the lower surface of the bottom steel plate 1. Moreover, the steel plate joint method of the invention may be applied to a joining position between any steel plates other than the bottom steel plate 1 and the splicing plate 2 as long as the joining position is a position which is desired to attach the bolt to a bolt hole provided in a predetermined steel plate located on the bolt insertion side in advance so as not to fall off when a plurality of steel plates are joined using the bolt. In addition, the bolt 5 can also be applied to a position where the bolt is disposed in an angular posture other than a posture with the head 5b downward. In this case, even if the bolt temporary fixing nut 13, 13A threadedly attached to the threaded portion 5a of the bolt 5 does not contact the bolt hole 3 of the steel plate which is to be temporarily fixed due to the weight of the bolt 5, when a pin tail 5c of the torque-shear-type high tensile bolt 5 is rotated in the fastening direction by a general-purpose mechanical driving tool, such as an impact wrench, the pin tail 5c may be slightly pushed in the axial direction such that the tapered portion 14 of the bolt temporary fixing nut 13, 13A is pressed against the bolt hole 3.

In addition, various changes can be made to the invention without departing from the scope of the invention.

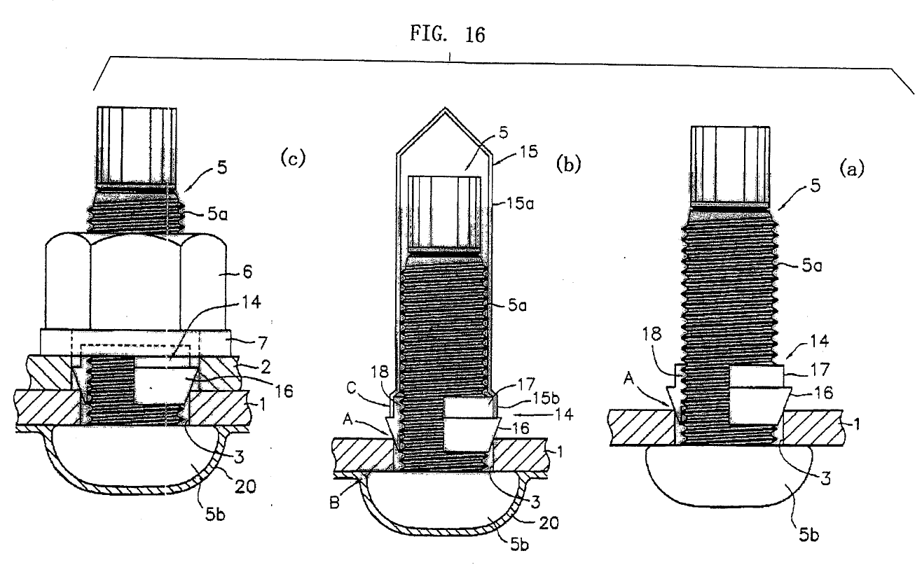

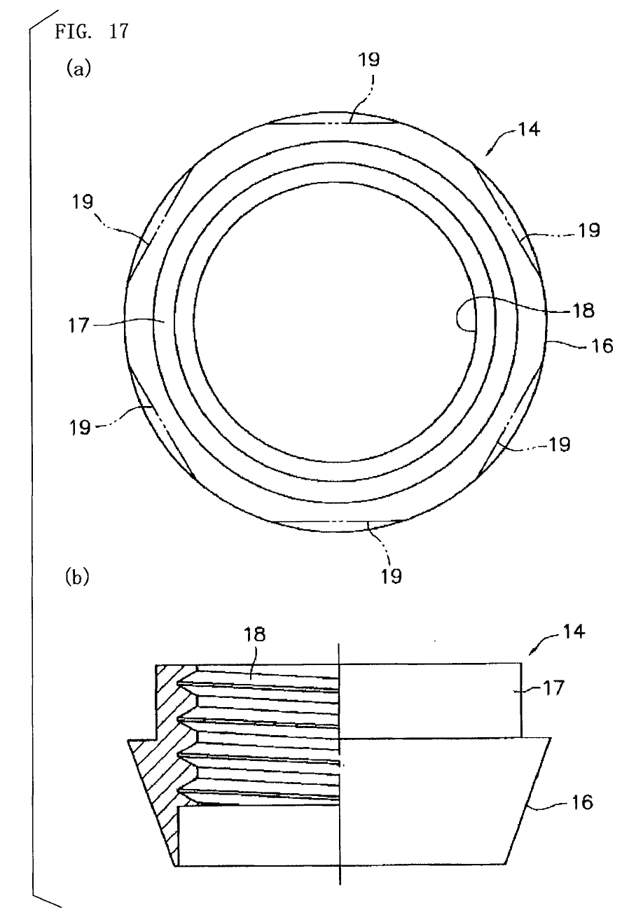

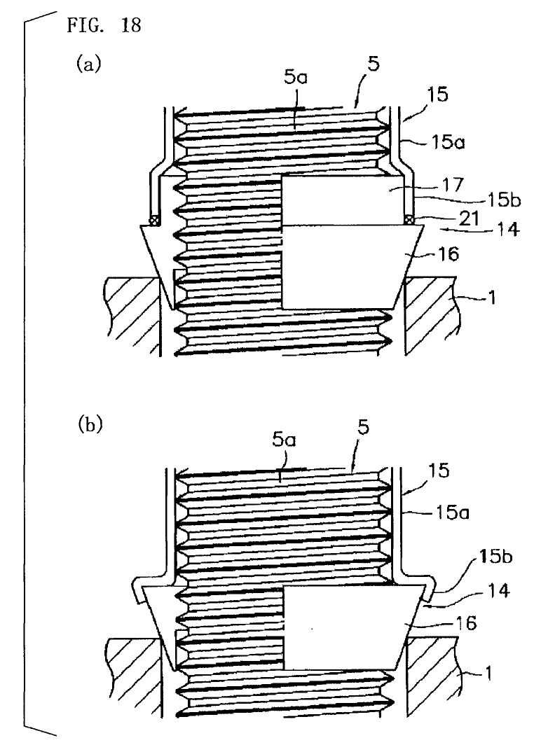

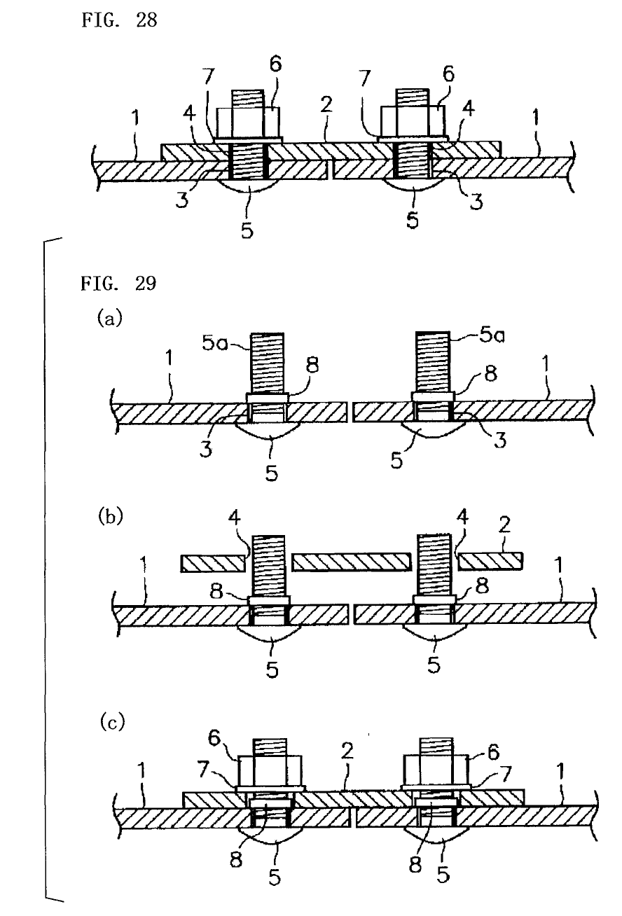

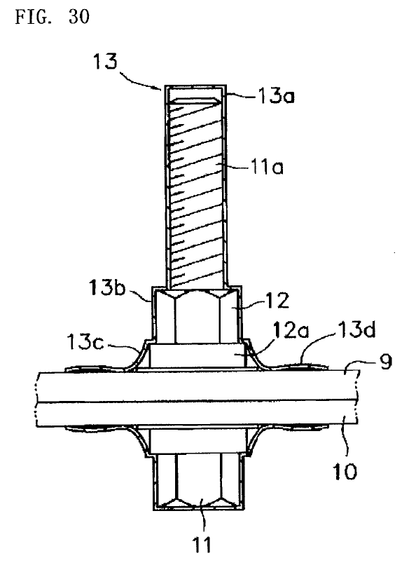

Hereinafter, another mode for carrying out the invention will be described in detail with reference to the drawings. (a), (b), and (c) of FIG. 16 and (a) and (b) of FIG. 17 show an embodiment of a rust-proofing method and apparatus of the fastening bolt of the invention and shows a case where the invention is applied to a junction between the bottom steel plate 1 and the splicing plate 2 of the same composite plate deck as that shown in FIG. 28, as two overlapping steel plates, by means of the bolt 5. This embodiment is performed in the following manner.

That is, the rust-proofing device of the fastening bolt of the invention, as shown in (b) of FIG. 16, is composed of a bolt temporary fixing nut 14 which can be brought into close contact with the inner peripheral surface of the upper end of the bolt hole 3, in a state where the nut is threadedly mounted on the threaded portion 5a of the bolt 5 inserted through the bolt hole 3 as one steel plate of the two overlapping steel plates from the lower surface, and a rust-proofing cap 15 provided with an opening 15b of the other longitudinal end which covers and seals the outer periphery of the upper end in the bolt temporary fixing nut 14 which protrudes above the bolt hole 3, in a state where one longitudinal end has a closed tubular shape and a body portion 15a at the side of the one longitudinal end is disposed so as to cover the tip and side surface of the threaded portion 5a of the bolt 5. Moreover, a portion between the head 5b of the bolt 5 and the lower surface of the bottom steel plate 1 can be sealed by performing painting on a desired region of the lower surface of the bottom steel plate 1 including the head 5b of the bolt 5 which is temporarily fixed to the bolt hole 3—in a state where its rotation is prevented by the fastening axial force onto the bolt temporary fixing nut 14 brought into close contact with the inner peripheral surface of the upper end of the bolt hole 3.

Specifically, the bolt temporary fixing nut 14 is equipped with a tapered portion 16 the external diameter of which is gradually increased from one axial end which has a smaller diameter than the bolt hole 3 provided in the bottom steel plate 1 to the other axial end which has a larger diameter than the bolt hole 3 by a desired amount, and is configured such that one axial end of the cylindrical cap attaching portion 17 which extends by a desired amount in the axial direction is integrally attached to the other axial end of the tapered portion 16.

An inner peripheral surface of the bolt temporary fixing nut 14 is provided with an internally threaded portion 18 for being threadedly attached to the threaded portion 5a of the bolt 5 which is to be used for the joining between the bottom steel plate 1 and the splicing plate 2. In addition, when a bolt 5, in which a region where no thread is engraved or an incomplete threaded portion exists in the under-head portion in the vicinity of the head 5b, is used as the bolt 5, a region with no thread may be provided at one axial end in the inner peripheral surface of the bolt temporary fixing nut 14 (in the drawing, the bolt temporary fixing nut 14 of a type in which a region with no thread is provided at one axial end in the inner peripheral surface is shown).

Moreover, the axial dimension of the bolt temporary fixing nut 14 is set so that the number of threads, which is needed to secure a sufficient fastening axial force for temporarily fixing the bolt 5, can be axially arrayed in the internally threaded portion 18 of the inner peripheral surface. Moreover, as will be described later, when the bolt 5 is fastened to the bolt temporary fixing nut 14 in a state where the tapered portion 16 is made to bite into the gap between the bolt hole 3 and the bolt 5 from the lower surface of the bottom steel plate 1, the amount, by which the other axial end of the cap attaching portion 17 which is the other axial end of the bolt temporary fixing nut 14 protrudes from the upper surface of the bottom steel plate 1, is set to be equal to or less than the thickness of the splicing plate 2. In addition, as shown in (c) of FIG. 16, in a case where a washer 7 which has a larger internal diameter than the external diameter of the other end of the bolt temporary fixing nut 14 is used as the washer 7 fitted to the bolt 5 at the time of the joining between the bottom steel plate 1 and the splicing plate 2 which is to be described later, the amount, by which the other axial end of the bolt temporary fixing nut 14 protrudes from the upper surface of the bottom steel plate 1 in a state where fastening of the bolt 5 has been performed, may be set to be an amount equal to or less than the sum of the thickness of the splicing plate 2 and the thickness of the washer 7.

The cap attaching portion 17 of the bolt temporary fixing nut 14 is configured such that its external diameter becomes smaller by a desired amount than the external diameter of the other axial end which is the side of the larger diameter in the tapered portion 16. This makes it possible to make small the external diameter of the opening 15b of the rust-proofing cap 15 for being covered on and attached to the outer periphery of the cap attaching portion 17. Consequently, even in a case where the dimensional difference between the internal diameter of the bolt hole 4 of the splicing plate 2 placed on and joined to the bottom steel plate 1 and the external diameter of the other axial end which is the side of the larger diameter of the tapered portion 16 of the bolt temporary fixing nut 14 is small, it is possible to obtain a configuration which is advantageous when the bolt 5 which is temporarily fixed to the bolt hole 3 is inserted through the bolt hole 4 of the splicing plate 2 with the rust-proofing cap 15 thereon.

In addition, as indicated by a two-dot chain line shown in (a) of FIG. 17, the bolt temporary fixing nut 14 may be configured such that six axial chamfers 19 are provided at regular intervals in the peripheral direction in the outer peripheral surface in the vicinity of the other axial end which is the side of the larger diameter in the tapered portion 16, and a fastening tool (not shown), such as a box wrench, may be hung on each of the chamfers 19, so that the screwing operation of the bolt temporary fixing nut 14 onto the bolt 5 can be performed using the fastening tool.

Moreover, the bolt temporary fixing nut 14 is made of, for example, synthetic resin, or metal, such as brass, steel, or aluminum, which is softer than the bottom steel plate 1 and the bolt 5, so that it can allow desired elastic deformation. This allows the bolt temporary fixing nut 14 to be screwed into a gap between the bolt hole 3 and the bolt 5 by the fastening axial force onto the bolt 5 as will be described later so that the bolt temporary fixing nut 14 can be made to bite into the gap between the bolt hole 3 and the bolt 5 in a wedge shape from one axial end of the tapered portion 16 up to a portion which is biased by a desired amount toward the other axial end which is closer to the larger diameter side than a position where the external diameter of the tapered portion 16 becomes equal to the bolt hole 3. Accordingly, the outer peripheral surface of the tapered portion 16 can be strongly pressed against the inner peripheral surface in the vicinity of an upper end of the bolt hole 3 over the entire length in the peripheral direction by the restoring force of the radial compressive elastic deformation caused in the portion of the tapered portion 16 of the bolt temporary fixing nut 14 biting into the gap between the bolt hole 3 and the bolt 5, so that a portion between the bolt temporary fixing nut 14 and the inner peripheral surface of the bolt hole 3 can be sealed. In addition, in a case where synthetic resin is used as the material of the bolt temporary fixing nut 14, the effect of more surely preventing the possibility that a minute gap resulting from any damage, etc. in a contact surface between metals may be formed between the outer peripheral surface of the tapered portion 16 of the bolt temporary fixing nut 14 and the inner peripheral surface in the vicinity of the upper end of the bolt hole 3 is expected.

The rust-proofing cap 15 is made of resin having flexibility, and the internal diameter of the opening 15b of the other longitudinal end is set to be slightly smaller than the external diameter of the cap attaching portion 17 of the bolt temporary fixing nut 14. Thereby, the opening 15b of the rust-proofing cap 15 is attached so as to cover the outer periphery of the cap attaching portion 17 of the bolt temporary fixing nut 14, so that the inner peripheral surface of the opening 15b of the rust-proofing cap 15 and the outer peripheral surface of the cap attaching portion 17 of the bolt temporary fixing nut 14 can be brought into close contact with each other, thereby sealing between the rust-proofing cap 15 and the bolt temporary fixing nuts 14.

Moreover, the body portion 15a of the rust-proofing cap 15 is set to have an internal diameter which is slightly smaller than the external diameter of the threaded portion 5a of the bolt 5. Thereby, if the body portion 15a of the rust-proofing cap 1S is covered on the threaded portion 5a of the bolt 5 from the tip side, the inner peripheral surface of the body portion 15a can be brought into close contact with the outer periphery of the threaded portion 5a of the bolt 5 over an axial long range. By the body portion 15a which is brought into close contact with to the outer periphery of the threaded portion 5a of the bolt 5 over the axial long range, a strong holding force for holding the rust-proofing cap 15 while being mounted on the bolt 5 can be exhibited. Accordingly, even if a slight external force is applied to the rust-proofing cap 15, as in a case where a person or an object collide against the rust prevention cap at the time of the conveyance, installation, etc. of the bottom steel plate 1, in a state where the rust-proofing cap 15 is mounted on the bolt 5 which is temporarily fixed to the bolt hole 3 via the bolt temporary fixing nut 14, the rust-proofing cap 15 coming out or fall off from a corresponding bolt 5 can be prevented.

In addition, the length of the rust-proofing cap 15 is set such that a sufficient margin to be easily pinched with a finger, a margin of about several centimeters for example, is formed between one end of the rust-proofing cap 15 and the tip of the threaded portion 5a of the bolt 5, in a state where the body portion 15a of the rust-proofing cap 15 is covered from the tip side of the threaded portion 5a of the bolt 5 which is temporarily fixed to the bolt hole 3 via the bolt temporary fixing nut 14, and the opening 15b is covered on and attached to the cap attaching portion 17 of the bolt temporary fixing nut 14. Since one end of the rust-proofing cap 15 in a state where the cap is mounted on the bolt 5 can be pinched with a finger and can be easily removed thereby, the workability of the removing operation of the rust-proofing cap 15 can be enhanced.

In a case where the rust-proofing of the bolt 5 used for the joining between the bottom steel plate 1 and the splicing plate 2 of the composite plate deck as two overlapping steel plates, similarly to that shown in FIG. 28, is performed using the rust-proofing device of the fastening bolt having the above configuration, in a state where the bolt 5 is temporarily fixed to the bolt hole 3, first, in a factory, etc., as shown in (a) of FIG. 16, the bolt (high tensile bolt) 5, for example, a torque-shear-type bolt is disposed so as to be inserted into the bolt hole 3. Thereafter, the bolt temporary fixing nut 14 is fitted to the threaded portion 5a of the bolt 5 from the one axial end where the tapered portion 16 is provided, thereby threadedly attaching the internally threaded portion 18. Thereafter, the bolt temporary fixing nut 14 is fastened to the bolt 5, and thereby, the tapered portion 16 of the bolt temporary fixing nut 14 is screwed and made to bite into the gap between the bolt hole 3 and the bolt 5 in a wedge shape from one end which becomes the side of the small diameter, utilizing the fastening axial force of the bolt temporary fixing nut 14 onto the bolt 5. At this time, in a case where the bolt temporary fixing nut 14 bites into the gap between the upper end of the bolt hole 3 and the bolt 5 to some extent, and is hard to rotate, a general-purpose box wrench, etc. may be used to rotate the tip of the torque-shear-type bolt 5 in the fastening direction of the bolt 5 and to fasten the bolt 5 to the bolt temporary fixing nut 14. In addition, in a case where the bolt 5 is a typical hexagonal bolt (high tensile bolt), the head 5b of the bolt 5 has only need to be rotated from the downside of the bottom steel plate 1 in the fastening direction.

Thereby, since a strong fastening axial force can be made to act on the bolt 5 from the bolt temporary fixing nut 14, a large frictional force will be generated between the bolt temporary fixing nut 14 and the bolt 5.

In addition, the bolt temporary fixing nut 14 is forcibly made to bite into the gap between the bolt hole 3 and the bolt 5 in a wedge shape up to a portion which has a larger diameter than the position in the tapered portion 16 which has the same diameter as the bolt hole 3 by the strong fastening axial force which is made to act on the bolt 5, and is thereby subjected to compressive elastic deformation in the gap between the bolt hole 3 and the bolt 5. By the restoring force of the bolt temporary fixing nut, the outer peripheral surface of the tapered portion 16 of the bolt temporary fixing nut 14 is strongly brought into close contact with the inner peripheral surface of the upper end of the bolt hole 3 over the entire length in the peripheral direction, a large frictional force will also be generated between the bolt temporary fixing nut 14 and the bolt hole 3. Consequently, the bolt 5 is temporarily fixed to the bolt hole 3 in a state where its rotation is prevented by the large frictional force between the bolt hole 3 and the bolt temporary fixing nut 14, and the large frictional force between the bolt temporary fixing nut 14 and the bolt 5.

Moreover, at this time, as the outer peripheral surface of the tapered portion 16 of the bolt temporary fixing nut 14 is strongly brought into close contact with the inner peripheral surface of the upper end of the bolt hole 3 over the entire length in the peripheral direction as described above, a portion (spot A in the drawing) between the bolt temporary fixing nut 14 and the inner peripheral surface of the upper end of the bolt hole 3 is sealed.

After the bolt 5 is temporarily fixed to the bolt hole 3 in a state where its rotation is prevented as described above, as shown in (b) of FIG. 16, painting serving as preliminary painting is performed on a desired region including the head 5b of the bolt 5 at the lower surface of the bottom steel plate 1, which is obtained by temporarily fixing the bolt 5 to the bolt hole 3 via the bolt temporary fixing nut 14, for example, on the whole surface of the lower surface of the bottom steel plate 1. Reference numeral 20 represents a paint film. Thereby, a portion (spot B in the drawing) between the head 5b of the bolt 5 and the lower surface of the bottom steel plate 1 is sealed.

In addition, the body portion 15a of the rust-proofing cap 15 is covered from the tip side on the threaded portion 5a of the bolt 5 which is temporarily fixed to the bolt hole via the bolt temporary fixing nut 14, and the opening 15b of the rust-proofing cap 15 is covered on and attached to the cap attaching portion 17 of the bolt temporary fixing nut 14. Thereby, a portion (spot C in the drawing) between the opening 15b of the rust-proofing cap 15 and the bolt temporary fixing nut 14 is sealed.

From the above, as the three spots A, B, and C in the drawings are sealed, contact of the threaded portion 5a of the bolt 5 with the ambient air can be cut off. Therefore, the rust-proofing of the threaded portion 5a of the bolt 5 is achieved.

Thereafter, the bottom steel plate 1 in which the bolt 5 is attached to the bolt hole 3 in the above manner is carried into a construction site. Then, the bottom steel plates 1 are disposed side by side in the direction of a span on a main girder. Thereafter, the splicing plate 2, which is obtained by boring a bolt hole 4 which is larger by a desired amount than the external diameter of the other axial end which is a larger diameter end of the cylindrical portion 16 of the bolt temporary fixing nut 14, is placed in a position corresponding to the bolt hole 3 of each of the bottom steel plates 1 as shown in (c) of FIG. 16 ((c) of FIG. 16 shows only one bottom steel plate 1) above the matching ends of the adjacent bottom steel plates 1 from the top such that the bolt 5 temporarily fixed to the bolt hole 3 is inserted through the bolt hole 4 of the splicing plate 2. At this time, the position of the bottom steel plate 1 in which the bolt 5 is temporarily fixed to the bolt hole 3 may be changed using the position of the bolt hole 4 of the splicing plate 2.

Thereafter, removal of the rust-proofing cap 15 is performed by pinching and pulling out one end of the rust-proofing cap 15 which is mounted on the threaded portion 5a of each bolt 5 which protrudes above the splicing plate 2. Then, overlapping portions of the bottom steel plate 1 and the splicing plate 2 are joined together by means of the bolt 5 by fitting the nut 6 onto the threaded portion 5a of each bolt 5 via the washer 7, and by fastening the nut 6 to the bolt 5. Thereby, the matching ends of the adjacent bottom steel plates 1 will be connected via the splicing plate 2.

Thus, according to the rust-proofing method and apparatus of the fastening bolt of the invention, the bolt 5 used for the joining between the bottom steel plate 1 and the splicing plate 2 of a composite plate deck is temporarily fixed to the bolt hole 3 via the bolt temporary fixing nut 14. Then, the threaded portion 5a of the bolt 5 can be cut off from the ambient air, and rust-proofing can be rapidly achieved by painting the lower surface of the bottom steel plate 1 including the head 5b of the bolt 5 and by installing the opening 15b of the rust-proofing cap 15 to be mounted on the threaded portion 5a of the bolt 5 in the cap attaching portion 17 of the bolt temporary fixing nut 14. Moreover, the rust-proofing effect can be made to last until the rust-proofing cap 15 is removed from the threaded portion 5a of the bolt 5 in order to finally fasten the nut 6 to the bolt 5 after the splicing plate 2 is placed on the bottom steel plate 1 which has been carried into the construction site.

In the above description, the internal diameter of the opening 15b of the rust-proofing cap 15 is made slightly smaller than the external diameter of the cap attaching portion 17 of the bolt temporary fixing nut 14, and the opening 15b of the rust-proofing cap 15 is attached so as to be covered on the outer periphery of the cap attaching portion 17 of the bolt temporary fixing nut 14, whereby the inner peripheral surface of the opening 15b of the rust-proofing cap 15 and the outer peripheral surface of the cap attaching portion 17 of the bolt temporary fixing nut 14 are brought into close contact with each other. However, as shown in (a) of FIG. 18, the internal diameter of the opening 15b of the rust-proofing cap 15 and the external diameter of the cap attaching portion 17 of the bolt temporary fixing nut 14 may be set to substantially the same diameter, and the tip of the opening 15b of the rust-proofing cap 15 covered on the outer periphery of the cap attaching portion 17 of the bolt temporary fixing nut 14 is brought into close contact with a sealant 21, such as an O ring, which is arranged in advance on a stepped portion of the bolt temporary fixing nut 14 formed between the cap attaching portion 17 and the tapered portion 16, thereby sealing a portion between the opening 15b of the rust-proofing cap 15 and the bolt temporary fixing nut 14.

Moreover, in the above description, the cylindrical cap attaching portion 17 is provided at the other axial end of the tapered portion 16 of the bolt temporarily fixing nut 14, and the opening 15b of the rust-proofing cap 15 is covered on and attached to the cap attaching portion 17. However, as shown in (b) of FIG. 18, the bolt temporary fixing nut 14 may be composed of only the tapered portion 16 from which the cylindrical cap attaching portion 17 is omitted, and the opening 15b of the rust-proofing cap 15 whose internal diameter is set to be slightly smaller than the external diameter thereof may be directly inserted into the outer periphery of the other axial end of the tapered portion 16. In this case, an outer peripheral portion itself of the other axial end, which is the side of the larger diameter of the tapered portion 16 protruding above the bolt hole 3 when the bolt 5 is temporarily fixed to the bolt hole 3, function as a cap attaching portion, and the outer peripheral surface of the tapered portion 16 in the vicinity of other axial end, which is the side of the larger diameter, functions as the bolt temporary fixing nut 14 provided with a circular configuration without the chamfers 19 as indicated by the two-dot chain line in (a) of FIG. 17. Even in this case, a portion between the tapered portion 16 of the bolt temporary fixing nut 14 and the opening 15b of the rust-proofing cap 15 can be sealed.

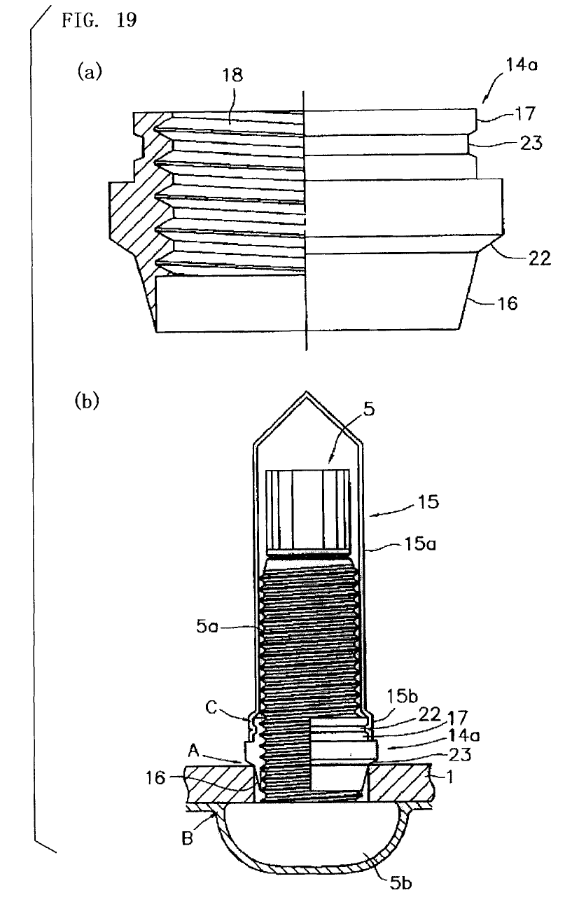

Next, (a) and (b) of FIG. 19 show a modification of the bolt temporary fixing nut shown in (a), (b), and (c) of FIG. 16 and (a) and (b) of FIG. 17 as another embodiment of the invention. In this embodiment, in the same configuration as the bolt temporary fixing nut 14 shown in (a) and (b) of FIG. 17, instead of configuring the outer peripheral surface of the tapered portion 16 into a continuously tapered shape which is gradually increased in diameter from one axial end which has a smaller diameter than the bolt hole 3 to the other axial end which has a larger diameter than the bolt hole 3, a bolt temporary fixing nut 14a is configured by providing a locking tapered surface 22, the inclination angle of which with respect to the axial direction is changed so as to be increased, at the other axial end of the portion where the external diameter in the outer peripheral surface of the same tapered shape as above is slightly larger than the diameter of the bolt hole 3.

Moreover, a groove 23 having a desired depth is provided at an axial intermediate portion of the cap attaching portion 17 over the entire length in the peripheral direction. Thereby, when the opening 15b of the rust-proofing cap 15 whose internal diameter is set to be slightly smaller than the external diameter of the cap attaching portion 17 of the bolt temporary fixing nut 14a is covered on the outer periphery of the cap attaching portion 17 of the bolt temporary fixing nut 14a, portions having high adhesiveness are formed in two axial positions across a portion having low adhesiveness, which is formed in a position corresponding to the groove 23 of the cap attaching portion 17, between the inner peripheral surface of the opening 15b of the rust-proofing cap 15 and the outer peripheral surface of the cap attaching portion 17 of the bolt temporary fixing nut 14a, so that the sealing performance between the opening 15b of the rust-proofing cap 15 and the cap attaching portion 17 of the bolt temporary fixing nut 14a can be further increased.

Other configurations are the same as those shown in (a) and (b) of FIG. 16 and (a) and (b) of FIG. 17 and the same reference numerals are given to the same components.

The bolt 5 is inserted through the bolt hole 3 from the bottom according to the same sequence shown in (a) of FIG. 16, using the bolt temporary fixing nut 14a having the above configuration. Thereafter, when the bolt temporary fixing nut 14a is fitted onto the threaded portion 5a of the bolt 5 from the small diameter side of the tapered portion 16 and the internally threaded portion 18 is threadedly attached and screwed to the threaded portion of the bolt, the tapered portion 16 of the bolt temporary fixing nut 14a is screwed into the gap between the bolt hole 3 and the bolt 5 from one axial end which is the side of the small diameter, similarly to the tapered portion 16 of the bolt temporary fixing nut 14 in the above embodiment, utilizing the fastening axial force of the nut 14a onto the bolt 5.

At this time, in the bolt temporary fixing nut 14a of this embodiment, the locking tapered surface 22 where the inclination angle with respect to the axial direction becomes large is provided at the other axial end of the portion where the external diameter in the outer peripheral surface becomes slightly larger than the diameter of the bolt hole 3. Therefore, when the locking tapered surface 22 reaches the upper end of the bolt hole 3, the force which bites into the gap between the bolt hole 3 and the bolt 5 becomes large. For this reason, since the adhesiveness of the bolt temporary fixing nut 14a to the inner peripheral surface of the upper end of the bolt hole 3 increases, the sealing performance between the inner peripheral surface of the upper end of the bolt hole 3 and the bolt temporary fixing nut 14a (portion A in (b) of FIG. 19) is further increased. In addition, it is possible to further strengthen the anti-rotational effect of the bolt 5 which is temporarily fixed by the fastening axial force onto the bolt temporary fixing nut 14a.

Moreover, since the longitudinal position of the bolt temporary fixing nut 14a with respect to the bolt hole 3 is determined, the fastening amount of the bolt 5 to the bolt temporary fixing nut 14a can be made constant. Moreover, even in a case where the bolt hole 3 is slightly larger than a designed dimension, the portion of the locking tapered surface 22 of the bolt temporary fixing nut 14a can be made to bite into the gap between the bolt hole 3 and the bolt 5 in a wedge shape. Therefore, the bolt 5 can be reliably fixed in a state where its rotation is prevented by the fastening axial force onto the bolt temporary fixing nut 14a.

As the bolt 5 is temporarily fixed to the bolt hole 3 via the bolt temporary fixing nut 14a as described above, after a portion (spot A in (b) of FIG. 19) between the inner peripheral surface of the upper end of the bolt hole 3 and the bolt temporary fixing nut 14a is sealed, similarly to that shown in (b) of FIG. 16, painting is performed at the lower surface of the bottom steel plate 1 including the head 5b of the bolt 5 which is temporarily fixed to the bolt hole 3, thereby sealing a portion (spot B in (b) of FIG. 19) between the head 5b of the bolt 5 and the lower surface of the bottom steel plate 1 by the paint film 20. In addition, the opening 15b of the rust-proofing cap 15, covered from the tip side on the threaded portion 5a of the bolt 5 which is temporarily fixed to the bolt hole 3 via the bolt temporary fixing nut 14a, is covered on and attached to the cap attaching portion 17 of the bolt temporary fixing nut 14a, thereby sealing a portion (spot C in (b) of FIG. 19) between the opening 15b of the rust-proofing cap 15 and the bolt temporary fixing nut 14a.

As described above, even by this embodiment, it is possible to seal the three spots A, B, and C in (b) of FIG. 19 to cut off the threaded portion 5a of the bolt 5 from the contact with ambient air, thereby achieving rust-proofing. Consequently, the same effects as the embodiment of (a) and (b) of FIG. 16 through (a) and (b) of FIG. 17 can be obtained.

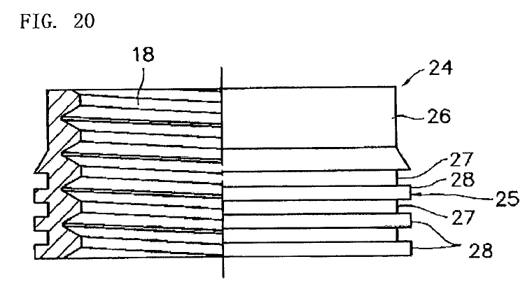

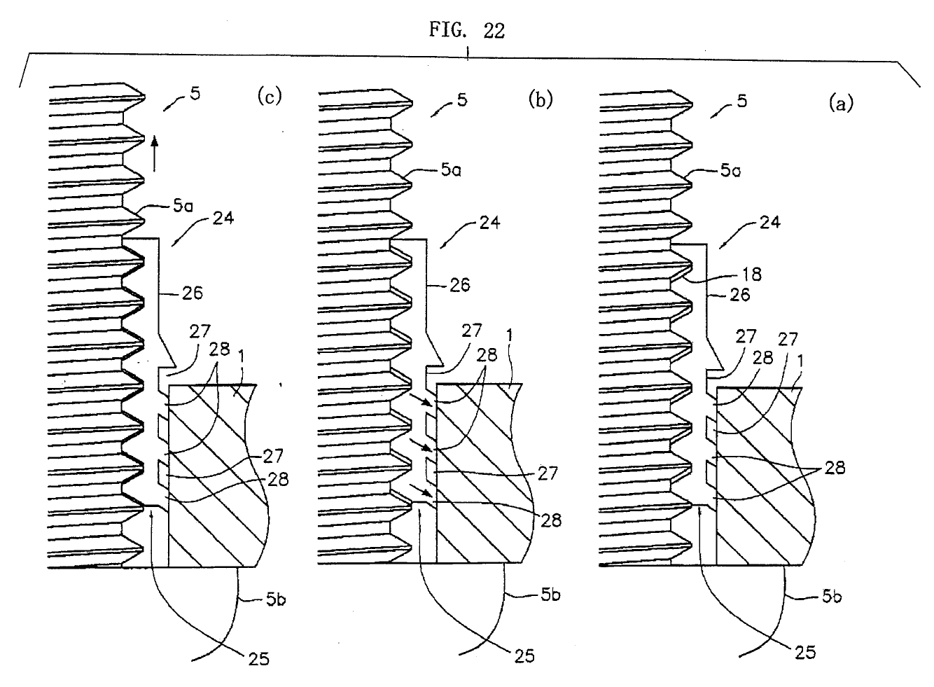

Next, FIG. 20 to (a), (b), and (c) of FIG. 22 show another example of the bolt temporary fixing nut as another embodiment of the invention. This embodiment is performed as follows.

That is, a bolt temporary fixing nut 24 of this embodiment, as shown in FIG. 20, has a shape in which a cylindrical cap attaching portion 26 which extends by a desired amount in the axial direction with a smaller diameter than the internal diameter of the bolt hole 3 is integrally provided at one axial end of a cylindrical portion 25 which has an external diameter which is larger by a desired amount than the internal diameter of the bolt hole 3, to which the bolt 5 used for the joining between the bottom steel plate 1 and the splicing plate 2 is to be temporarily fixed, and the inner peripheral surface of the bolt temporary fixing nut is provided with the internally threaded portion 18 for being threadedly attached to the threaded portion 5a of the bolt 5. Specifically, the external diameter of the bolt temporary fixing nut 24 is set to an amount which is, for example, about 0.5 mm larger than the internal diameter of the bolt hole 3. In a case where the internal diameter of the bolt hole 3 is 25 mm, the external diameter of the bolt temporary fixing nut is set to about 25.5 mm.

In addition, in positions having desired intervals in the axial direction at the outer periphery of the cylindrical portion 25 of the bolt temporary fixing nut 24, a plurality of ring-shaped grooves 27 are provided with such a depth that the diameter at the inside of the groove 27 becomes smaller by a desired amount than the internal diameter of the bolt hole 3, and an annular projecting portion 28 is formed between the adjacent grooves 27.

In addition, in the internally threaded portion 18 of the bolt temporary fixing nut 24 is configured such that, if a region where no thread is engraved exists in the under-head portion in the vicinity of the head 5b of the bolt 5, or even in a case where imperfect threads exist in the under-head portion, one axial end of the bolt temporary fixing nut 24 for being threadedly attached to the threaded portion 5a of the bolt 5 in the vicinity of the bolt head 5b is screwed up to a position which is spaced with a desired gap, for example, up to a position separated by about 2 to 3 mm, from the head 5b of the bolt 5.

The axial dimension of the bolt temporary fixing nut 24 is set so that the number of threads which is needed to secure a sufficient fastening axial force for temporarily fixing the bolt 5 as will be described later can be axially arrayed of the internally threaded portion 18 of the inner peripheral surface. In addition, in a state where the bolt temporary fixing nut 24 is screwed onto the threaded portion 5a of the bolt 5 to a position which is separated by a predetermined dimension from the head 5b as described above, the other axial end of the cylindrical portion 25 in the bolt temporary fixing nut 24 on the side of the bolt head 5b is disposed at the upper end of the bolt hole 3, and the distance to the other axial end of the cap attaching portion 26 from the bolt head 5b is set to be a dimension equal to or less than the sum of the thickness of the bottom steel plate 1 and the thickness of the splicing plate 2. In addition, in a case where a washer 7 which has a larger internal diameter than the external diameter of the bolt temporary fixing nut 24 is used, as the washer 7 fitted to the bolt 5, when the bottom steel plate 1 and the splicing plate 2 are joined together, the axial dimension of the bolt temporary fixing nut 24 may be set such that the distance to the other axial end of the cap attaching portion 26 from the bolt head 5b becomes a dimension equal to or less than the sum of the thickness of the bottom steel plate 1, the thickness of the splicing plate 2, and the thickness of the washer 7, in a state where the bolt temporary fixing nut 24 is screwed onto the threaded portion 5a of the bolt 5 to a position which is separated by a predetermined dimension from the head 5b as described above.

Moreover, the material of the bolt temporary fixing nut 24 includes the same material as the bolt temporary fixing nut 14 in the embodiment of (a), (b), and (c) of FIG. 16, and FIG. 17 so that it can allow desired elastic deformation. Thereby, the bolt temporary fixing nut 24 can be forcibly pushed into the bolt hole 3 together with the bolt 5 in a state where the bolt temporary fixing nut 24 is threadedly attached to a predetermined position in the threaded portion 5a of the bolt 5 as described above. Also, the outer peripheral surface of the cylindrical portion 25 is brought into close contact with the inner peripheral surface of the bolt hole 3 by the restoring force of the radial compressive elastic deformation which is caused as the cylindrical portion 25 in the bolt temporary fixing nut 24 is forcibly pushed into the gap between the bolt hole 3 and the bolt 5, so that the bolt temporary fixing nut 24 can be fixed to the inside of the bolt hole 3.

A stepped portion between the other axial end of the cylindrical portion 25 of the bolt temporary fixing nut 24 and the cap attaching portion 26 has a tapered shape whose corner is chamfered. Thereby, it is possible to enhance the workability when the cylindrical portion 25 of the bolt temporary fixing nut 24 in a state of being attached to the threaded portion 5a of the bolt 5 as described above is pushed into the bolt hole 3.

In addition, in FIG. 20 to (a), (b), and (c) of FIG. 22, the same reference numerals are given to the same components as those shown in (a), (b), and (c) of FIG. 16, and (a) and (b) of FIG. 17.

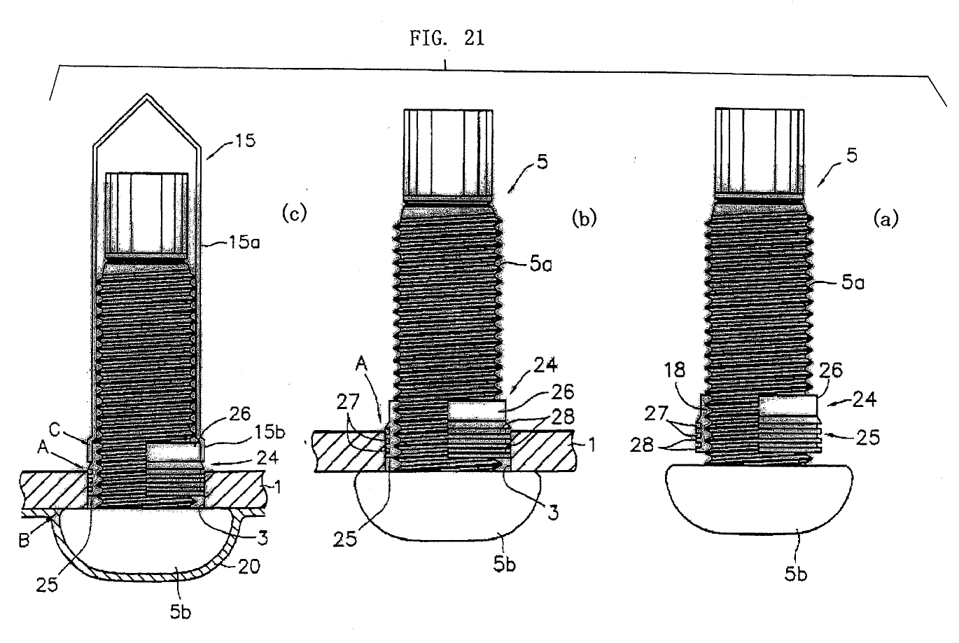

In a case where the bolt temporary fixing nut 24 having the above configuration is used, first, in a factory, etc., as shown in (a) of FIG. 21, the bolt temporary fixing nut 24 is threadedly attached to the threaded portion 5a of the bolt (high tensile bolt) 5 used for the joining between the bottom steel plate 1 and the splicing plate 2, and is screwed up to a position where the distance between one axial end in the vicinity of the bolt head 5b in the bolt temporary fixing nut 24 and the bolt head 5b becomes about 2 to 3 mm.

Next, as shown in (b) of FIG. 21, the bolt 5 is forcibly pushed into the bolt hole 3 from the bottom to a position where the bolt head 5b abuts on the lower surface of the bottom steel plate 1 together with the bolt temporary fixing nut 24 which is threadedly attached in advance. By the restoring force of the cylindrical portion 25 of the bolt temporary fixing nut 24 which undergoes compressive elastic deformation in the radial direction between the inner peripheral surface of the bolt hole 3 and the threaded portion 5a of the bolt 5, and the outer peripheral surface of the cylindrical portion 25 is brought into close contact with the inner peripheral surface of the bolt hole 3, and the bolt temporary fixing nut 24 is fixed to the inside of the bolt hole 3. Consequently, the bolt 5 threadedly attached to the bolt temporary fixing nut 24 fixed to the bolt hole 3 is held without falling off in a state of being inserted through the bolt hole 3.

Next, the bolt 5 is rotated in the fastening direction, thereby fastening the bolt 5 to the bolt temporary fixing nut 24 fixed to the inside of the bolt hole 3.

Hereinafter, the pushing operation of pushing the bolt 5 to which the bolt temporary fixing nut 24 is threadedly attached into the bolt hole 3, and the behavior of the bolt temporary fixing nut 24 at the time of the bolt fastening operation after the pushing operation will be described in detail. First, when the bolt temporary fixing nut 24 is pushed into the bolt hole 3 in a state of being threadedly attached to the bolt 5, as shown in (a) of FIG. 22, the internally threaded portion 18 of the inner peripheral surface is pushed upward by the threaded portion 5a of the bolt 5 threadedly mounted on the internally threaded portion 18, while friction acts between the outer peripheral surface of the cylindrical portion 25 of the bolt temporary fixing nut 24 and the inner peripheral surface of the bolt hole 3. Therefore, each of the annular projecting portions 28 provided on the outer peripheral surface of the cylindrical portion 25 is deformed such that its outer peripheral portion is turned down (tilted). Thereafter, when fastening of the bolt 5 to the bolt temporary fixing nut 24 is performed, as shown in (b) of FIG. 22, a downward force acts on the internally threaded portion 18 of the inner peripheral surface of the bolt temporary fixing nut 24 by the threaded portion 5a of the bolt 5 whose upward displacement is prevented as the head 5b abuts on the lower surface of the bottom steel plate 1. Therefore, a compressive force will act on each of the annular projecting portions 28 of the outer peripheral surface of the bolt temporary fixing nut 24, along the turned-over direction (tilted direction) of the annular projecting portions 28 at the time of pushing to the bolt hole 3. For this reason, the adhesiveness of the outer peripheral surface of each of the annular projecting portions 28 of the cylindrical portion 25 of the bolt temporary fixing nut 24 to the inner peripheral surface of the bolt hole 3 increases, and the bolt temporary fixing nut 24 is more firmly fixed to the inside of the bolt hole 3. Consequently, the bolt 5 is temporarily fixed to the bolt hole 3 in a state where its rotation is prevented by a strong fastening axial force which is caused as the bolt is fastened to the bolt temporary fixing nut 24.

In addition, since the outer peripheral surface of the cylindrical portion 25 in the bolt temporary fixing nut 24 is brought into close contact with an inner peripheral surface including the upper end of the bolt hole 3, a portion between the inner peripheral surface of the upper end of the bolt hole 3 and the bolt temporary fixing nuts 24 (portion A in (b) of FIG. 21) is sealed. Moreover, since the plurality of ring-shaped grooves 27 are provided in positions having desired intervals in the axial direction in the outer peripheral surface of the cylindrical portion 25 of the bolt temporary fixing nut 24. A labyrinth-seal-like structure is formed downward from the upper end of the bolt hole 3, between the outer peripheral surface of the cylindrical portion 25 and the inner peripheral surface of the bolt hole 3. Accordingly, the certainty of sealing between the inner peripheral surface of the upper end of the bolt hole 3, and the bolt temporary fixing nut 24 is increased even by this labyrinth-seal-like structure.

In addition, generally, in a case where an external thread and an internal thread are screwed together, some play is provided between a thread and a screw groove. Accordingly, even if the threaded portion 5a of the bolt 5 stretches more or less when the nut 6 is finally fastened to the bolt 5 in order to join overlapping portions of the bottom steel plate 1 and the splicing plate 2 similarly to (c) of FIG. 16 in a subsequent step, as shown in (c) of FIG. 22, the thread of the threaded portion 5a of the bolt 5 is displaced inside the play of the screw groove of the internally threaded portion 18 of the bolt temporary fixing nut 24 fixed to the inside of the bolt hole 3. Thus, the stretch of the bolt 5 is not restrained at all. Consequently, the joining between the bottom steel plate 1 and the splicing plate 2 by means of the bolt 5 and the nut 6 is reliably performed by a predetermined fastening axial force.

After the bolt 5 is temporarily fixed to the bolt hole 3 via the bolt temporary fixing nut 24 as shown in (b) of FIG. 21, and a portion (spot A in (b) of FIG. 21) between the inner peripheral surface of the upper end of the bolt hole 3 and the bolt temporary fixing nut 24 is sealed, as shown in (c) of FIG. 21, similarly to that shown in (b) of FIG. 16, painting is performed at the lower surface of the bottom steel plate 1 including the head 5b of the bolt 5 which is temporarily fixed to the bolt hole 3, thereby sealing a portion (spot B in (c) of FIG. 21) between the head 5b of the bolt 5 and the lower surface of the bottom steel plate 1 by the paint film 20. In addition, the opening 15b of the rust-proofing cap 15 covered from the tip side on the threaded portion 5a of the bolt 5 which is temporarily fixed to the bolt hole 3 via the bolt temporary fixing nut 24 may be covered on and attached to the cap attaching portion 26 of the bolt temporary fixing nut 24, thereby sealing a portion (spot C in (c) of FIG. 21) between the opening 15b of the rust-proofing cap 15 and the bolt temporary fixing nut 24.

As described above, even by the bolt temporary fixing nut 24 of this embodiment, it is possible to seal the three positions A, B, and C in (c) of FIG. 21. It is thus possible to cut off the threaded portion 5a of the bolt 5 from the contact with ambient air, thereby achieving rust-proofing. Consequently, the same effects as the embodiment of (a), (b), and (c) of FIG. 16 to (a) and (b) of FIG. 17 can be obtained. Moreover, since the screwing operation of the bolt temporary fixing nut 24 onto the bolt can be performed in a location which is different from a site where the temporary fixing operation of the bolt 5 to the bottom steel plate 1 is performed, the working efficiency of the screwing operation of the bolt temporary fixing nut 24 onto the bolt 5 can be made high.

In addition, the bolt 5 onto which the bolt temporary fixing nut 24 is screwed is pushed into the bolt hole 3 together with the bolt temporary fixing nut 24, so that the bolt 5 can be held by the bolt hole 3 via the bolt temporary fixing nut 24 so as not to fall. Moreover, fastening of the bolt 5 onto the bolt temporary fixing nut 24 fixed to the bolt hole 3 is done by only rotating the bolt 5 in its fastening direction, and does not need the holding of the bolt temporary fixing nut 24. Consequently, the concurrent operation on both the upper and lower surfaces of the bottom steel plate 1 becomes unnecessary. Thereby, labor hours and manpower can be reduced.

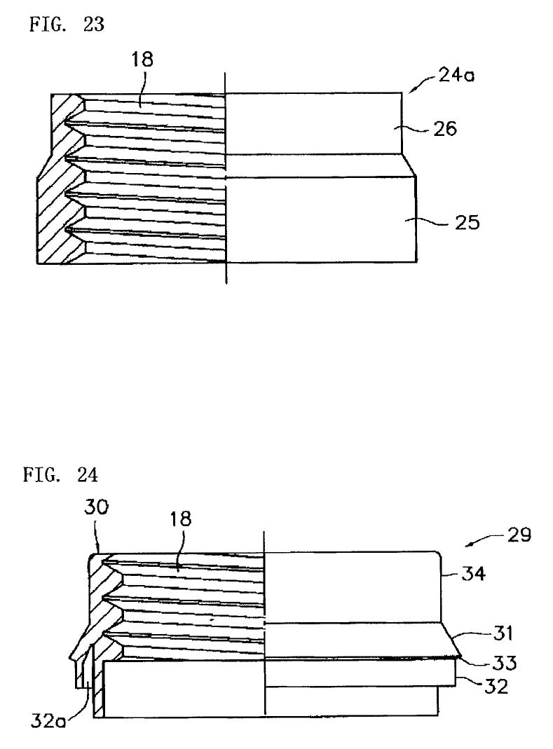

Next, FIG. 23 shows another example of the bolt temporary fixing nut as another embodiment of the invention. In this embodiment, in the same configuration as the bolt temporary fixing nut 24 shown in FIG. 20, a bolt temporary fixing nut 24a in which the grooves 27 of the outer peripheral surface of the cylindrical portion 25 are omitted, and the outer peripheral surface is formed as a cylindrical surface which is flat in the axial direction is provided.

In addition, when the bolt temporary fixing nut 24a of this embodiment having the above configuration is forcibly pushed into the bolt hole 3 together with the bolt 5 in a state of being screwed onto the threaded portion 5a of the bolt 5, there is no portion which can be bent and deformed like the annular projecting portions 28 in the bolt temporary fixing nut 24 shown in (a), (b), and (c) of FIG. 22. Consequently, the external diameter of the bolt temporary fixing nut 24a of this embodiment may be set to be slightly smaller than the external diameter of the bolt temporary fixing nut 24 shown in FIG. 19 within a range having a larger dimension than the internal diameter of the bolt hole 3, or the material of the bolt temporary fixing nut 24a may be a material whose acceptable amount of elastic deformation is slightly larger compared with the bolt temporary fixing nut 24 shown in FIG. 20.

Other configurations are the same as those shown in FIG. 20, and the same reference numerals are given to the same components.

Even by the bolt temporary fixing nut 24a of this embodiment having the above configuration, according to the same sequence as that shown in (a), (b), and (c) of FIG. 21, the sealing between the bolt temporary fixing nut 24a and the inner peripheral surface of the upper end of the bolt hole 3 can be performed by temporarily fixing the bolt 5 to the bolt hole 3 via the bolt temporary fixing nut 24a pushed into and fixed to the bolt hole 3, and bringing the outer peripheral surface of the cylindrical portion 25 into close contact with the inner peripheral surface including the upper end of the bolt hole 3.

Consequently, the same effects as the embodiment of (a), (b), and (c) of FIG. 20 to (a), (b), and (c) of FIG. 22 can be obtained even by this embodiment. In addition, since the bolt temporary fixing nut 24a has a simple configuration, the effect of reducing the manufacturing cost of the bolt temporary fixing nut 24a can be expected.

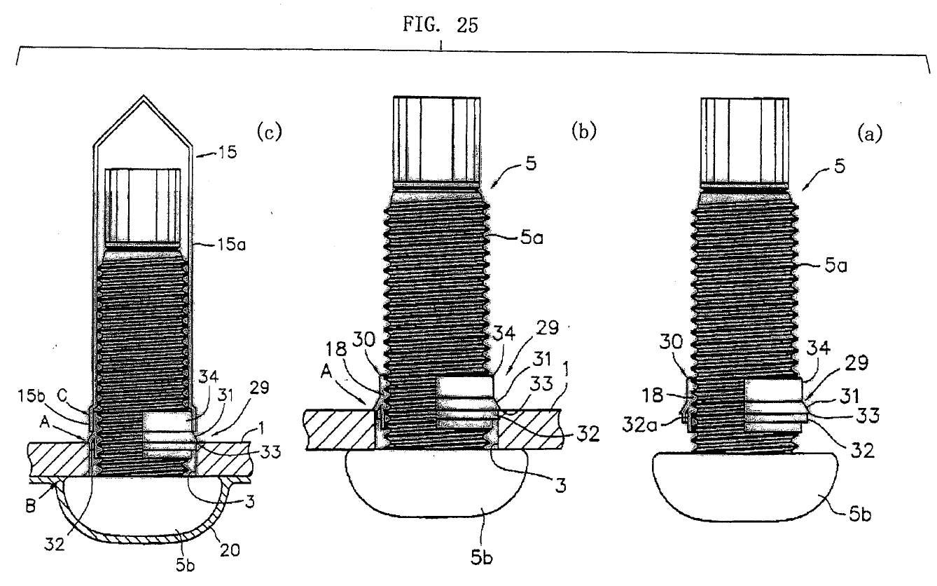

Next, FIG. 24 to (a), (b), and (c) of FIG. 25 show another example of the bolt temporary fixing nut as another embodiment of the invention. This embodiment is performed as follows.

That is, in a bolt temporary fixing nut 29 in this embodiment, as shown in FIG. 24, an inner peripheral surface of a cylindrical member 30 having an external diameter which is smaller by a desired amount than the internal diameter of the bolt hole 3 is provided with the internally threaded portion 18 for being threadedly attached to the threaded portion 5a of the bolt 5.

An axial intermediate portion in the outer peripheral surface of the cylindrical member 30 is provided with a tapered locking protruding portion 31 whose diameter is gradually increased from one axial side which is the vicinity of the tip of the threaded portion 5a toward the other axial side which is the vicinity of the bolt head 5b at the time of screwing to the threaded portion 5a of the bolt 5, and the external diameter at the other axial end of which becomes larger by a desired amount than the internal diameter of the bolt hole 3.

Moreover, a cylindrical portion 32 having the same external diameter as or having an external diameter which is slightly larger than the internal diameter of the bolt hole 3 is attached to the other axial end of the locking protruding portion 31 so as to extend by a desired amount toward the other axial end of the cylindrical member 30, and a slightly tapered stepped portion 33 is provided between the other axial end of the locking protruding portion 31 and the cylindrical portion 32. A spatial portion 32a having a desired width in the radial direction is provided between a portion in the vicinity of the other axial end of the tapered locking protruding portion 31, the inner peripheral surface of the cylindrical portion 32, and the outer peripheral surface of the cylindrical member 30, so that the elastic deformation of a portion in the vicinity of the other axial end of the locking protruding portion 31 and the cylindrical portion 32 toward the side of the axial center can be permitted.

In addition, a portion which is closer to one axial end than the locking protruding portion 31 in the cylindrical member 30 is made to function as a cap attaching portion 34.

The axial amount of the bolt temporary fixing nut 29, as will be described later, is set such that the amount of projection of one axial end of the cylindrical member 30 from the upper surface of the bottom steel plate 1 is equal to or less than the thickness of the splicing plate 2, in a state where the bolt 5 has been fastened to the bolt temporary fixing nut 29 locked to a peripheral edge of the bolt hole 3 in the upper surface of the bottom steel plate 1 by the locking protruding portion 31, from the lower surface of the bottom steel plate 1. In addition, in a case where a washer 7, which has a larger internal diameter than the external diameter of the cylindrical member 30 of the bolt temporary fixing nut 29, is used as the washer 7 fitted to the bolt 5 when the bottom steel plate 1 and the splicing plate 2 are joined together, the amount of projection of one axial end of the cylindrical member 30 from the upper surface of the bottom steel plate 1, in a state where the bolt 5 has been fastened, may be set so as to be an amount equal to or less than the sum of the thickness of the splicing plate 2 and the thickness of the washer 7.

The material of the bolt temporary fixing nut 29 includes the same material as the bolt temporary fixing nut 14 in the embodiment of (a), (b), and (c) of FIG. 16, and (a) and (b) of FIG. 17.

In addition, in FIG. 24 and (a), (b), and (c) of FIG. 25, the same reference numerals are given to the same components as those shown in (a), (b), and (c) of FIG. 16, and (a) and (b) of FIG. 17.

In a case where the bolt temporary fixing nut 29 having the above configuration is used, first, in a factory, etc., as shown in (a) of FIG. 25, the bolt temporary fixing nut 29 is threadedly attached to the threaded portion 5a of the bolt (high tensile bolt) 5 used for the joining between the bottom steel plate 1 and the splicing plate 2, and is screwed until the cylindrical portion 32 is arranged in a position away from the bolt head 5b by the thickness of the bottom steel plate 1.

Next, as shown in (b) of FIG. 25, the bolt 5 is pushed into the bolt hole 3 from the bottom to a position where the head 5b of the bolt 5 abuts on the lower surface of the bottom steel plate 1 together with the bolt temporary fixing nut 29 which is threadedly attached in advance. Thereby, the bolt temporary fixing nut 29 is pushed into a position where the cylindrical portion 32 is arranged inside the upper end of the bolt hole 3. At this time, when the tapered locking protruding portion 31 which has once been elastically deformed toward the axial center as being pushed into the bolt hole 3 passes through the bolt hole 3, the shape of the protruding portion is restored so as to be open axially outward above the bottom steel plate 1. Consequently, since the stepped portion 33 provided between the locking protruding portion 31 and the cylindrical portion 32, which is arranged inside the bolt hole 3, is stopped by the peripheral edge of the bolt hole 3 in the upper surface of the bottom steel plate 1, the bolt 5 threadedly attached to the bolt temporary fixing nut 29 is held without falling off in a state of being inserted through the bolt hole 3. In addition, at this time, as the outer peripheral surface of the cylindrical portion 32 of the bolt temporary fixing nut 29 touches the inner peripheral surface of the bolt hole 3, the free rotation of the bolt temporary fixing nut 29 is also limited.

Next, if the bolt 5 is rotated in the fastening direction, the bolt 5 is fastened to the bolt temporary fixing nut 29 whose free rotation is limited, and which is stopped at the peripheral edge of the bolt hole 3 in the upper surface of the bottom steel plate 1 by means of the stepped portion 33 provided at the other axial end of the locking protruding portion 31. Thereby, the bolt 5 is temporarily fixed to the bolt hole 3 where its rotation is prevented by a strong fastening axial force caused in the bolt temporary fixing nut 29. In addition, at this time, as the stepped portion 33 having tapered shape slightly bites into the upper end of the bolt hole 3 and is brought into close contact therewith, a portion (spot A in (b) of FIG. 25) between the inner peripheral surface of the upper end of the bolt hole 3 and the bolt temporary fixing nuts 29 is sealed.

After the bolt 5 is temporarily fixed to the bolt hole 3 via the bolt temporary fixing nut 29 as shown in (b) of FIG. 25, and a portion (spot A in (b) of FIG. 25) between the inner peripheral surface of the upper end of the bolt hole 3 and the bolt temporary fixing nut 29 is sealed, as shown in (c) of FIG. 25, similarly to that shown in (b) of FIG. 16, painting is performed at the lower surface of the bottom steel plate 1 including the head 5b of the bolt 5 which is temporarily fixed to the bolt hole 3, thereby sealing a portion (spot B in (c) of FIG. 25) between the head 5b of the bolt 5 and the lower surface of the bottom steel plate 1 by the paint film 20. In addition, the opening 15b of the rust-proofing cap 15 covered from the tip side on the threaded portion 5a of the bolt 5 which is temporarily fixed to the bolt hole 3 via the bolt temporary fixing nut 29 may be covered on and attached to the cap attaching portion 34 of the bolt temporary fixing nut 29, thereby sealing a portion (spot C in (c) of FIG. 25) between the opening 15b of the rust-proofing cap 15 and the bolt temporary fixing nut 29.

As described above, even by the bolt temporary fixing nut 29 of this embodiment, it is possible to seal the three spots A, B, and C in (c) of FIG. 25. It is thus possible to cut off the threaded portion 5a of the bolt 5 from the contact with ambient air, thereby achieving rust-proofing. Consequently, the same effects as the embodiment of (a), (b), and (c) of FIG. 16 through (a) and (b) of FIG. 17 can be obtained.

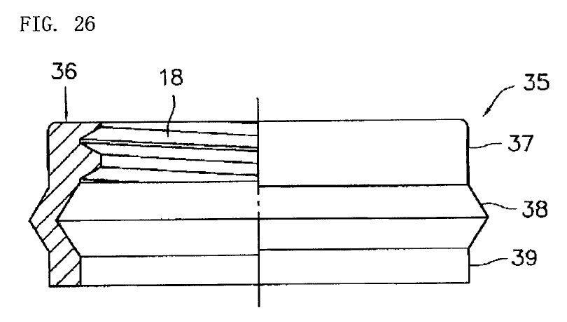

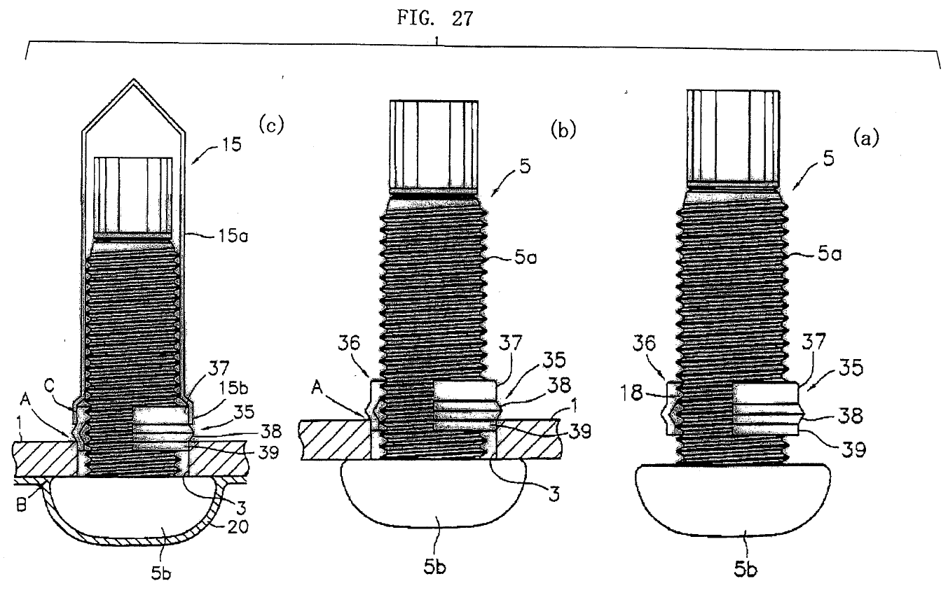

FIG. 26 to (a), (b), and (c) of FIG. 27 show another example of the bolt temporary fixing nut another embodiment of the invention. This embodiment is performed as follows.

That is, in a bolt temporary fixing nut 35 in this embodiment, as shown in FIG. 26, an inner peripheral surface of a cylindrical member 36, the external diameter of which is smaller by a desired amount than the internal diameter of the bolt hole 3 and an outer peripheral surface of which is used as a cap attaching portion 37, is provided with the internally threaded portion 18 for being threadedly attached to the threaded portion 5a of the bolt 5.

A locking protruding portion 38 which has a ring shape, having a chevron-shaped cross section, curved radially outward at an axial intermediate portion, and the external diameter at the apex of which is larger by a desired amount than the internal diameter of the bolt hole 3 is integrally attached to the one axial end of the cylindrical member 36.

Moreover, a cylindrical portion 39 which extends by a desired amount in the axial direction with the same or slightly larger external diameter than the internal diameter of the bolt hole 3 is integrally attached to the one axial end of the locking protruding portion 38.

The axial dimension of the bolt temporary fixing nut 35, as will be described later, is set such that the amount of projection of the other axial end of the cylindrical member 36 from the upper surface of the bottom steel plate 1 is equal to or less than the thickness of the splicing plate 2, in a state where the bolt 5 has been fastened to the bolt temporary fixing nut 35 locked to a peripheral edge of the bolt hole 3 in the upper surface of the bottom steel plate 1 by the locking protruding portion 38, from the lower surface of the bottom steel plate 1. In addition, in a case where a washer 7 which has a larger internal diameter than the external diameter of the cylindrical member 36 of the bolt temporary fixing nut 35 is used as the washer 7 fitted to the bolt 5 when the bottom steel plate 1 and the splicing plate 2 are joined together, the amount of projection of the other axial end of the cylindrical member 36 from the upper surface of the bottom steel plate 1 may be set so as to be an amount equal to or less than the sum of the thickness of the splicing plate 2 and the thickness of the washer 7.

The material of the bolt temporary fixing nut 35 includes the same material as the bolt temporary fixing nut 14 in the embodiment of (a), (b), and (c) of FIG. 16, and (a) and (b) of FIG. 17.

In addition, in FIG. 26 and (a), (b), and (c) of FIG. 27, the same reference numerals are given to the same components as those shown in (a), (b), and (c) of FIG. 16 and (a) and (b) of FIG. 17.

In a case where the bolt temporary fixing nut 35 having the above configuration is used, in a factory, etc., as shown in (a) of FIG. 27, the bolt temporary fixing nut 35 is first threadedly attached to the threaded portion 5a of the bolt 5 used for the joining between the bottom steel plate 1 and the splicing plate 2 from one axial end, and is screwed until the cylindrical portion 39 is arranged in a position away from the bolt head 5b by the thickness of the bottom steel plate 1.

Next, as shown in (b) of FIG. 27, the bolt 5 is pushed into the bolt hole 3 from the bottom up to a position where the head 5b of the bolt 5 abuts on the lower surface of the bottom steel plate 1 together with the bolt temporary fixing nut 35 which is threadedly attached in advance. Thereby, the bolt temporary fixing nut 35 is pushed into a position where the cylindrical portion 39 is arranged inside the upper end. At this time, when the locking protruding portion 38 having a chevron-like section is first elastically deformed so as to be crushed toward the axial center as being pushed into the bolt hole 3, and then passes through the bolt hole 3, the shape of the locking protruding portion 38 which has been elastically deformed is restored so as to protrude radially outward above the bottom steel plate 1. Consequently, since the locking protruding portion 38 is locked to the peripheral edge of the bolt hole 3 in the upper surface of the bottom steel plate 1, the bolt 5 threadedly attached to the bolt temporary fixing nut 35 is held without falling off in a state of being inserted through the bolt hole 3. In addition, at this time, since the outer peripheral surface of the cylindrical portion 39 of the bolt temporary fixing nut 35 touches the inner peripheral surface of the bolt hole 3, the free rotation of the bolt temporary fixing nut 35 is also limited.

Next, if the bolt 5 is rotated in the fastening direction, the bolt 5 is fastened to the bolt temporary fixing nut 35, whose free rotation is limited, and which is locked to the peripheral edge of the bolt hole 3 in the upper surface of the bottom steel plate 1 by means of the locking protruding portion 38. Thereby, the bolt 5 is temporarily fixed to the bolt hole 3 by a strong fastening axial force caused in the bolt temporary fixing nut 35 which is fixed as the locking protruding portion 38 is made to slightly bite into the gap between the bolt hole 3 and the bolt 5. In addition, at this time, as the locking protruding portion 38 bites into the gap between the upper end of the bolt hole 3 and the bolt 5 and is brought into close contact with the inner peripheral surface of the upper end of the bolt hole 3, a portion (spot A in (b) of FIG. 27) between the inner peripheral surface of the upper end of the bolt hole 3 and the bolt temporary fixing nuts 35 is sealed.

After the bolt 5 is temporarily fixed to the bolt hole 3 off the bottom steel plate 1 via the bolt temporary fixing nut 35 as shown in (b) of FIG. 27, and a portion (spot A in (b) of FIG. 27) between the inner peripheral surface of the upper end of the bolt hole 3 and the bolt temporary fixing nut 35 is sealed, as shown in (c) of FIG. 27, similarly to that shown in (b) of FIG. 16, painting is performed at the lower surface of the bottom steel plate 1 including the head 5b of the bolt 5 which is temporarily fixed to the bolt hole 3, thereby sealing a portion (spot B in (c) of FIG. 27) between the head 5b of the bolt 5 and the lower surface of the bottom steel plate 1 by the paint film 20.

In addition, the opening 15b of the rust-proofing cap 15 covered from the tip side on the threaded portion 5a of the bolt 5 which is temporarily fixed to the bolt hole 3 via the bolt temporary fixing nut 35 may be covered on and attached to the cap attaching portion 37 of the bolt temporary fixing nut 35, thereby sealing a portion (spot C in (c) of FIG. 27) between the opening 15b of the rust-proofing cap 15 and the bolt temporary fixing nut 35.

As described above, even by the bolt temporary fixing nut 35 of this embodiment, it is possible to seal the three positions A, B, and C in (c) of FIG. 27. It is thus possible to cut off the threaded portion 5a of the bolt 5 from the contact with ambient air, thereby achieving rust-proofing. Consequently, the same effects as the embodiments of FIG. 16 to FIG. 17 can be obtained.

The invention is not limited only to the above embodiments. For example, the radial amount and axial amount of the cap attaching portion 17, 26, 34, and 37 in the bolt temporary fixing nuts 14, 14a, 24, 24a, 29 and 35 may be suitably changed according to the dimension of the bolt hole 3, the thickness of the splicing plate 2, the amount of the bolt hole 4, the size of the bolt 11, the internal diameter of the opening 15b of the rust-proofing cap 15, etc.

In the embodiments of FIG. 16 to FIG. 17, and FIG. 19, the external diameter of the cap attaching portion 17 of each of the bolt temporary fixing nuts 14 and 14a may be set to the same amount as the external diameter of the other axial end which is the side of the larger diameter of the tapered portion 16. In addition, in the embodiments of FIG. 20, FIG. 22, and FIG. 23, the external diameter of the cap attaching portion 26 of each of the bolt temporary fixing nuts 24 and 24a may be set to the same dimension as the external amount of cylindrical portion 25. In this case, if the bolt hole 4 of the splicing plate 2 is set to have a larger internal diameter than the cap attaching portion 17 of each of the bolt temporary fixing nuts 14 and 14a, or the external diameter of the cap attaching portion 26 of each of the bolt temporary fixing nuts 24 and 24a, the rust-proofing cap 15 can be removed after the splicing plate 2 is placed on the bottom steel plate 1. In addition, if necessary, removing the rust-proofing cap 15 before the splicing plate 2 is placed on the bottom steel plate 1 is not limited at all.

The inclination angle of the tapered portion 16 of the bolt temporary fixing nut 14 with respect axial direction in the embodiments of FIG. 16 to FIG. 18, and the inclination angles of the tapered portion 16 and the locking tapered surface 22 with respect to the axial direction in the embodiment of (a) and (b) of FIG. 19 may be suitably changed according to the thickness of the bottom steel plate 1 and the splicing plate 2 to be joined together, and the size of the gap between the bolt hole 3 and bolt 5 provided in one steel plate to which the bolt 5 is attached in advance.

The external diameter of the bolt temporary fixing nut 24 in the embodiments of FIG. 20 to FIG. 23 may be increased or decreased from 0.5 mm in the ratio which is set to be larger in diameter than the bolt hole 3, according to its material, the diameter dimension of the bolt hole 3 to which the bolt 5 is to be temporarily fixed, etc., so long as the nut is pushed into the bolt hole 3 together with the bolt 5 in a state where the nut is screwed onto the bolt 5, and is fixed to the inside of the bolt hole 3.

In addition, the width, axial array interval, array number, depth, etc. of the grooves 27 provided in the outer peripheral surface of the bolt temporary fixing nut 24 or of the annular projecting portions 28 formed between the adjacent grooves 27 in the embodiments of FIG. 20 to FIG. 23 may be suitably changed according to the size of the bolt temporary fixing nut 24, etc.

The axial intermediate portion in the cap attaching portion 17 of the bolt temporary fixing nut 24 of the embodiments of FIG. 20 to FIG. 22, the cap attaching portion 17 of the bolt temporary fixing nut 24a of the embodiment of FIG. 23, the cap attaching portion 34 of the bolt temporary fixing nut 29 of the embodiments of FIG. 24 and FIG. 25, and the cap attaching portion 37 of the bolt temporary fixing nut 35 of the embodiments of FIG. 26 and FIG. 27 may be provided with the same grooves as the grooves 23 provided in the cap attaching portion 17 of the bolt temporary fixing nut 14a shown in (a) and (b) of FIG. 19.

The rust-proofing method and apparatus of the fastening bolt of the invention may be applied to a joining spot between any steel plates other than the bottom steel plate 1 and the splicing plate 2 as long as the joining spot is a spot which is desired to attach the bolt 5 to a bolt hole provided in one steel plate in advance so that the bolt 5 does not fall off when two steel plates are joined using the bolt 5.

In addition, it is needless to say that various changes can be made to the invention without departing from the scope of the invention.

1. A bolt temporary fixing nut for temporarily fixing a bolt, which is inserted through overlapping portions of a plurality of steel plates for joining the plurality of steel plates, at a bolt hole of a predetermined steel plate of the plurality of steel plates, the nut comprising:
a cylindrical portion which forms a nut body;
an internally threaded portion provided at an inner periphery of the cylindrical portion; and
a tapered portion provided at an outer periphery of the cylindrical portion,
wherein the tapered portion is gradually reduced in diameter as it goes toward one end surface of the cylindrical portion from the other end surface thereof in an axial direction of the cylindrical portion,
the maximum external diameter of the tapered portion is larger than the internal diameter of the bolt hole, and
the minimum external diameter of the tapered portion is smaller than the internal diameter of the bolt hole.

2. The bolt temporary fixing nut according to claim 1,
wherein the tapered portion has a first tapered surface in the vicinity of the one end surface and a second tapered surface in the vicinity of the other end surface, and
the inclination angle of the second tapered surface to the axial direction is larger than the inclination angle of the first tapered surface to the axial direction.

3. The bolt temporary fixing nut according to claim 2,
wherein the external diameter of a boundary between the first tapered surface and the second tapered surface is larger than the bolt hole.

4. The bolt temporary fixing nut according to claim 1,
wherein a thread-less portion in which the internally threaded portion is not formed is formed at an inner peripheral surface of the cylindrical portion in the vicinity of the one end surface.

5. The bolt temporary fixing nut according to claim 1,
wherein the cylindrical portion is made of elastically deformable resin.

6. The bolt temporary fixing nut according to claim 1,
wherein a cap attaching portion is formed at an outer peripheral surface of the cylindrical portion in the vicinity of the other end surface, and the external diameter of the cap attaching portion is smaller than the external diameter of the cylindrical portion.

7. A bolt temporary fixing method comprising: inserting a bolt through a bolt hole of one steel plate of two overlapping steel plates, which are to be joined using the bolt, from one surface of the one steel plate, and then threadedly attaching the bolt temporary fixing nut according to claim 1 to a shank of the bolt from one end surface of the cylindrical portion, and screwing the one end surface of the bolt temporary fixing nut into a gap between the bolt hole of the one steel plate and the bolt, thereby temporarily fixing the bolt to the one steel plate in advance.

8. A steel plate joining method comprising: temporarily fixing the bolt to the one steel plate in advance by the bolt temporary fixing method according to claim 7, then disposing the other steel plate, in which a bolt hole which is larger than the maximum diameter of the bolt temporary fixing nut is bored, at the other surface of the one steel plate, and then threadedly attaching and fastening the nut to the bolt, thereby joining the two overlapping steel plates.

9. A steel plate joining method comprising: temporarily fixing the bolt to the one steel plate in advance by the bolt temporary fixing method according to claim 7, then preliminarily painting a region including a head of the bolt at one surface of the one steel plate, then disposing the other steel plate, in which a bolt hole which is larger than the maximum diameter of the bolt temporary fixing nut is bored, at the other surface of the one steel plate, and then threadedly attaching and fastening the nut to the bolt, thereby joining the two overlapping steel plates.

10. A rust-proofing method of a fastening nut using the bolt temporary fixing nut according to claim 1 comprising: temporarily fixing a bolt inserted through a bolt hole of one steel plate of two overlapping steel plates, which are to be joined using the bolt, from one surface of the one steel plate, via the bolt temporary fixing nut, and sealing an end on the side of the other surface at an inner peripheral surface of the bolt hole of the one steel plate by an outer peripheral surface of the bolt temporary fixing nut, thereby preventing water from entering the bolt hole, and bringing an opening at the other axial end of a rust-proofing cap, one longitudinal end of which is a closed tubular shape for covering the tip and side surface of a threaded portion of the bolt, into contact with the bolt temporary fixing nut, thereby sealing a portion between the opening of the rust-proofing cap and the bolt temporary fixing nut, and sealing a portion between the head of the bolt and the one surface of the one steel plate by painting.

11. A rust-proofing method of a fastening nut using the bolt temporary fixing nut according to claim 1 comprising: temporarily fixing a bolt inserted through a bolt hole of one steel plate of two overlapping steel plates, which are to be joined using the bolt, from one surface of the one steel plate, via the bolt temporary fixing nut, sealing an end on the side of the other surface at an inner peripheral surface of the bolt hole of the one steel plate at an outer peripheral surface of the bolt temporary fixing nut, thereby preventing water from entering the bolt hole, then sealing a portion between the head of the bolt and the one surface of the one steel plate by painting, and bringing an opening at the other axial end of a rust-proofing cap, one longitudinal end of which is a closed tubular shape for covering the tip and side surface of a threaded portion of the bolt, into contact with the bolt temporary fixing nut, thereby sealing a portion between the opening of the rust-proofing cap and the bolt temporary fixing nut

12. The rust-proofing method of a fastening nut according to claim 10,
wherein the bolt, to which the bolt temporary fixing nut having an external diameter larger than the bolt hole by a desired amount is threadedly attached, is pushed into the bolt hole of one steel plate of the two overlapping steel plates together with the bolt temporary fixing nut from one surface of the one steel plate, thereby temporarily fixing the bolt, and sealing a portion between an end on the side of the other surface at the inner peripheral surface of the bolt hole of the one steel plate and the bolt temporary fixing nut.

13. The rust-proofing method of a fastening nut according to claim 10,
wherein the bolt, to which the bolt temporary fixing nut including a locking protruding portion having an external diameter larger than the bolt hole by a desired amount is threadedly attached, is pushed into the bolt hole of one steel plate of the two overlapping steel plates together with the bolt temporary fixing nut from one surface of the one steel plate until the locking protruding portion of the bolt temporary fixing nut passes through the bolt hole of the one steel plate and appears at the other surface, then the locking protruding portion of the bolt temporary fixing nut is pushed into a gap between the bolt hole of the one steel plate and the bolt in a direction opposite to the pushing direction of the bolt, thereby temporarily fixing the bolt, and sealing a portion between an end on the side of the other surface at the inner peripheral surface of the bolt hole of the one steel plate and the bolt temporary fixing nut.

14. A rust-proofing apparatus of a fastening nut using the bolt temporary fixing nut according to claim 1 comprising:
the bolt temporary fixing nut which is brought into close contact with an end on the side of the other surface at the bolt hole of the one steel plate, in a state of being threadedly mounted on a threaded portion of a bolt inserted through a bolt hole of one steel plate of two overlapping steel plates, which are to be joined using the bolt, from one surface of the one steel plate, and
a rust-proofing cap whose one longitudinal end is made into a closed tubular shape, and having a body portion at one longitudinal end covered on the tip and side surface of the threaded portion of the bolt, and an opening at the other axial end brought into contact with the bolt temporary fixing nut, thereby sealing a portion between the opening and the bolt temporary fixing nut,
wherein a portion between the head of the bolt and the one surface of the one steel plate is sealed by painting.

15. The rust-proofing apparatus of a fastening nut according to claim 14,
wherein the bolt temporary fixing nut has a cap attaching portion for attaching the rust-proofing cap at the tapered portion on the side of the other end surface of the cylindrical portion.

16. The rust-proofing apparatus of a fastening nut according to claim 15,
wherein a locking tapered surface portion, the inclination angle of which with respect to an axial direction increases, is provided at the side of the other axial end of the tapered portion whose external diameter is larger than the bolt hole of the one steel plate by a desired amount.

17. The rust-proofing apparatus of a fastening nut according to claim 14,
wherein the bolt temporary fixing nut is configured to have a cap attaching portion for attaching the rust-proofing cap at the side of the one axial end of the cylindrical portion having an external diameter which is larger by a desired dimension than the bolt hole of one steel plate of the two overlapping steel plates, wherein
by being pushed into the bolt hole of the one steel plate in a state of being threadedly attached to the threaded portion of the bolt, the bolt temporary fixing nut can be brought into close contact with and fixed to the inside of the bolt hole by the restoring force of elastic deformation which is compressed in the radial direction in the gap between the bolt hole and the bolt.

18. The rust-proofing apparatus of a fastening nut according to claim 17,
wherein ring-shaped grooves are provided at a plurality of positions of axially desired intervals in the outer peripheral surface of the cylindrical portion of the bolt temporary fixing nut.

19. The rust-proofing apparatus of a fastening nut according to claim 14,
wherein the bolt temporary fixing nut comprises:
a cylindrical member having a diameter which is smaller than the bolt hole of one steel plate of the two overlapping steel plates, and having an outer peripheral surface at the other end surface of the cylindrical portion in the axial direction of the bolt temporary fixing nut as a cap attaching portion for attaching the rust-proofing cap, and
a locking protruding portion which has a larger diameter than the bolt hole of the one steel plate, which is elastically deformable toward the axial center, at an axial intermediate portion of the cylindrical member.

20. The rust-proofing apparatus of a fastening nut according to claim 19,
wherein a cylindrical portion, which has a diameter equal to or slightly larger than the bolt hole of the one steel plate of the two overlapping steel plates, is provided closer to the side of the other axial end surface of the cylindrical portion than the locking protruding portion in the bolt temporary fixing nut.

21. The rust-proofing apparatus of a fastening nut according to claim 14,
wherein a groove is provided at an axial intermediate portion of a cylindrical cap attaching portion of the bolt temporary fixing nut.
